(19) United States
(12) Patent Application Publication
(10) Pub. No.: US 2015/0303546 A1
(43) Pub. Date: Oct. 22, 2015

(54) DIELECTRIC STRAP WAVEGUIDES, ANTENNAS, AND MICROWAVE DEVICES

(71) Applicants: The University of Manitoba, Winnipeg (CA); The University of Saskatchewan, Saskatoon (CA)

(72) Inventors: Atabak Rashidian, Winnipeg (CA); Lotfollah Shafai, Winnipeg (CA); David M. Klymyshyn, Winnipeg (CA); Mohammadreza Tayfeh Aligodarz, Saskatoon (CA)

(73) Assignees: The University of Manitoba, Winnipeg, MB (CA); The University of Saskatchewan, Saskatoon, SK (CA)

(21) Appl. No.: 14/410,369

(22) PCT Filed: Jun. 21, 2013
(86) PCT No.: PCT/IB2013/001973

§ 371 Date: Dec. 22, 2014

Related U.S. Application Data
(60) Provisional application No. 61/663,417, filed on Jun. 22, 2012.

(51) Int. Cl. H01P 3/08; H01P 1/20; H01P 11/00; H01P 5/18

(52) U.S. Cl. CPC H01P 3/081; H01P 5/184; H01P 1/20; H01P 11/006

(57) ABSTRACT

A new class of antennas and microwave components are introduced. In this approach a high-permittivity dielectric film is applied (i.e. printed) on a dielectric substrate, which may be grounded. By changing the shape of the high-permittivity film, different microwave devices (e.g. waveguides, filters, couplers, and antennas) are produced. By changing the size and permittivity of the high-permittivity film and dielectric substrate, these elements are designed at different frequencies for different applications. Highly-efficient microwave devices can result due to the absence of surface currents.

### CROSS-REFERENCE TO RELATED APPLICATIONS

This application claims the benefit of priority of U.S. Provisional Patent Application No. 61/663,417 to Shafai et al. filed on Jun. 22, 2012, and entitled “Apparatus, System, and Method for Dielectric Strap Waveguides, Antennas, and Microwave Devices,” which is hereby incorporated by reference in its entirety.

### BACKGROUND

1. Field of the Invention

This invention relates generally to microwave devices, such as antennas, waveguides, couplers, and the like such as those used in telecommunications devices, sensor devices, and other electromagnetic transmitters and receivers. More particularly, the invention relates to high-efficiency, inexpensive planar transmission line antennas, microstrip antennas, and other space conserving and/or high frequency antennas for use in telecommunications devices, sensor devices, and other devices including, but not limited to cellular phone devices, satellite transmission and receiving devices, remote sensing devices, high-frequency transmitters/receivers, and other electronic devices.

2. Description of the Related Art

For many years, planar metallic microwave structures, such as microstrip lines, microstrip filters, and microstrip antennas, have been extensively used in telecommunications and sensor devices. These structures may consist of a metallic strip/patch placed above a grounded substrate and usually fed through a coaxial probe or an aperture. The large popularity of the planar metallic microwave components is due to this fact that it is inexpensive to manufacture using modern printed-circuit technology. However, the energy loss in most of these components is dominated by a frequency dependent metal loss due to the finite conductivity of metals and the skin effect. Therefore, the efficiency of these elements is not high, especially at upper microwave, millimeter-wave and higher frequencies, and a considerable portion of the input energy is wasted due, for example, to the surface current loses in the metal.

On the other hand, conventional dielectric microwave elements such as dielectric resonator antennas are three dimensional structures which are mostly fabricated from hard ceramics. The dielectric components offer many appealing features and performance advantages over their metallic counterparts (e.g. higher efficiency and bandwidth, miniaturized structure). However, ceramic-based structures involve a more complex and costly fabrication process due in part to their three-dimensional structure and in part due to the abrasive nature of the ceramic material. Conventional machining fabrication has been limited to relatively simple and large structures. Mass production by machining is not an attractive option since the hardness of ceramic requires diamond cutting tools, which wear out relatively quickly due to the abrasive material. Array structures are even more difficult to fabricate due to the requirement of individual element placement and bonding to the substrate.

Dielectric resonator antennas (DRAs) provide high radiation efficiency which makes them suitable at millimeter-wave frequencies, where the loss in metallic antennas, such as microstrip patch antennas, is significant. However fabrication of DRAs is challenging due to their tiny structures and the high precision required at these frequencies. Different solutions have been previously introduced in the literature. For instance a larger DRA was designed and fabricated to operate at higher-order modes to alleviate the tolerance and size problems (Pan et al., 2011). Polymer-based DRAs were also introduced to simplify the fabrication process because of their natural softness and possibility of constructing DRAs using deep polymer-based lithographies (Rashidian et al., 2010).

Recently, traditional printers are modified to produce dielectric films with any desired shape. This technology is known as “thin/thick film technology” and can deliver ceramic films with a thickness from approximately 10 nm to over 100 μm. The fabrication of ceramic films can be divided in three steps: (1) the synthesis of ceramic powder which is usually performed by some thermal treatments, (2) the shaping of the ceramic films by mixing the ceramic powder in a solvent and depositing the mixture by screen printing, inkjet printing, 3D printing, layer deposition, or other deposition methods, and (3) a densification step by evaporation of solvent, or by solid-state sintering. Depending on the fabrication processes and parameters, the ceramic film can achieve permittivities over 1000 and dielectric loss tangent less than 0.01 at gigahertz frequencies. So far, microwave applications of ceramic film technology are concentrated on tunable microwave devices using BST (barium-strontium-titanate: a kind of ceramic material) film on a top side of the substrate. In those applications, by depositing (e.g., printing) metallic microwave structures on BST films and applying an external electrostatic field, the permittivity of ceramic film is changed, which enables the realization of tunable metallic microwave devices.

### SUMMARY OF THE INVENTION

A radically different approach is described here to exploit ceramic films directly, as highly-efficient dielectric microwave devices without using metallic structures. In this approach the ceramic film of very high-permittivity is printed on another dielectric body of low-permittivity to realize antennas, waveguides, and other microwave devices.

A new class of antennas and other microwave components are introduced. In this approach a high-permittivity dielectric film is applied (e.g., printed) on a dielectric substrate, which may be grounded. By changing the shape of the high-permittivity film, different microwave devices (e.g. waveguides, filters, couplers, and antennas) are produced. By changing the size and permittivity of the high-permittivity film and dielectric substrate, these elements are designed at different frequencies for different applications. Highly-efficient microwave devices are resulted due to the absence of surface currents.

In certain embodiments, the invention relates to high-efficiency antennas, waveguides, filters, transmission lines and other electric components employing dielectric films and dielectric substrates that improve energy efficiency and allow the manufacture of such elements without metallic components, thus avoiding the surface currents inherent in some metallic components.

In certain embodiments, the invention relates to planar antennas, waveguides, couplers, and other electromagnetic devices that benefit from their planar nature, including but not limited to, reduced component size, ease of fabrication, or physical flexibility such as the ability to be bent.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 shows a Dielectric Strap Waveguide (DSW) according to one embodiment of the disclosure.

FIG. 2 shows the frequency response of a DSW according to one embodiment of the disclosure.

FIG. 3 shows the cutoff frequency of a DSW with different widths according to certain embodiments of the disclosure.

FIG. 4 shows the cutoff frequency of a DSW with different substrate thicknesses according to certain embodiments of the disclosure.

FIG. 5 shows the cutoff frequency of a DSW with different substrate permittivities according to certain embodiments of the disclosure.

FIG. 6 shows the characteristic impedance of the DSW according to one embodiment of the disclosure.

FIGS. 7A and 7B shows the DSW with two microstrip line transitions in the ports according to one embodiment of the disclosure.

FIGS. 8A-B show (a) electric field intensity and (b) electric field vectors on x-y cross section of the DSW according to certain embodiments of the disclosure.

FIGS. 9A-B show (a) electric field intensity and (b) electric field vectors on y-z cross section of the DSW according to certain embodiments of the disclosure.

FIG. 10 shows frequency response of 8 mm DSW with 1 mm long microstrip line transitions at its two ends according to certain embodiments of the disclosure.

FIG. 11 shows frequency response of 18 mm DSW with 1 mm long microstrip line transitions at its two ends according to certain embodiments of the disclosure.

FIG. 12 shows DSW attenuation at 60 GHz for different dielectric losses of the strap according to certain embodiments of the disclosure.

FIG. 13 shows DSW attenuation at 60 GHz for different dielectric losses of the substrate according to certain embodiments of the disclosure.

FIGS. 14A-E show examples of resulting dielectric strap electromagnetic components and antennas including examples of parallel plate structures in FIGS. 14A and FIG. 14D, examples of periodic structures in FIG. 14B and FIG. 14C, and examples of isolated structures in FIG. 14E.

FIGS. 15A-B show example of a dielectric strap coupler according to certain embodiments of the disclosure.

FIGS. 16A-C show frequency response of the coupler with different spacings S according to certain embodiments of the disclosure.

FIGS. 17A-B shows a dielectric strap antenna (DSA) element according to one embodiment of the disclosure.

FIGS. 18A-B shows electric near-field distributions for the DSA according to certain embodiments of the disclosure.

FIG. 19 shows reflection coefficients of the DSA according to certain embodiments of the disclosure.

FIGS. 20A-B show radiation patterns of a DSA according to certain embodiments of the disclosure, including the yz plane (or E plane) in FIG. 20A and the xz (or H plane) in FIG. 20B.

FIG. 21 shows a peak realized gain of the DSA according to certain embodiments of the disclosure.

FIG. 22 shows radiation efficiency of the DSA according to certain embodiments of the disclosure.

FIG. 23 shows a peak realized gain of the DSA for tan δ₂=0.1 (ε″=30) according to certain embodiments of the disclosure.

FIG. 24 shows radiation efficiency of the DSA for tan δ₂=0.1 (ε″=30) according to certain embodiments of the disclosure.

FIGS. 25A-B show an example of a rectangular DSA with small dimensions according to certain embodiments of the disclosure.

FIG. 26 shows reflection coefficient of the DSA with small dimensions according to certain embodiments of the disclosure.

FIGS. 27A-B show an example of a rectangular DSA with large dimensions according to one embodiment of the disclosure.

FIG. 28 shows reflection coefficient of the DSA with large dimensions according to certain embodiments of the disclosure.

FIGS. 29A-B show normalized radiation patterns of a DSA with large dimensions according to certain embodiments of the disclosure, including the yz plane (or E plane) in FIG. 29A and the xz plane (or H plane) in FIG. 29B.

FIGS. 30A-B show a DSA with multi-layer substrate according to one embodiment of the disclosure.

FIG. 31 shows reflection coefficients of a DSA with a multi-layer substrate according to certain embodiments of the disclosure.

FIGS. 32A-B show a peak realized gain and efficiency of a DSA with multi-layer substrate according to certain embodiments of the disclosure.

FIGS. 33A-B show DSAs with a modified microstrip line excitation according to certain embodiments of the disclosure.

FIG. 34 shows reflection coefficients of a DSA with a modified microstrip line excitation according to certain embodiments of the disclosure.

FIGS. 35A-B show a DSA excited by coplanar waveguide according to certain embodiments of the disclosure.

FIG. 36 shows reflection coefficients of a DSA excited by a coplanar waveguide according to certain embodiments of the disclosure.

FIG. 37A-B shows a DSA excited by a slot excitation method according to one embodiment of the disclosure.

FIG. 38 shows a reflection coefficient of a DSA excited by a slot excitation method according to one embodiment of the disclosure.

FIG. 39 shows a DSW with parallel dielectric straps on a top side and a bottom side of a substrate according to one embodiment of the disclosure.

FIG. 40 shows a frequency response of a waveguide according to one embodiment of the disclosure.

FIG. 41 shows a DSW with a dielectric strap printed on a top side of a substrate according to one embodiment of the disclosure.

FIG. 42 shows a frequency response of a waveguide according to one embodiment of the disclosure.

FIGS. 43A-B show electric and magnetic near-field distributions of the structure of FIG. 41 according to one embodiment of the disclosure.

FIGS. 44A-B show a two-layer DSW according to one embodiment of the disclosure.

FIGS. 45A-B show a frequency response of a waveguide according to one embodiment of the disclosure.

### DESCRIPTION OF ILLUSTRATIVE EMBODIMENTS

The term “coupled” is defined as connected, although not necessarily directly, and not necessarily mechanically. Two items are “couplable” if they can be coupled to each other. The coupling between two items can be, for example, electromagnetic, for which the electromagnetic energy flows from one item to the other item. Unless the context explicitly requires otherwise, items that are couplable are also decouplable, and vice-versa. One non-limiting way in which a first structure is couplable to a second structure is for the first structure to be configured to be coupled to the second structure. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, an apparatus or kit, or a component of an apparatus or kit, that “comprises,” “has,” “includes” or “contains” one or more elements or features possesses those one or more elements or features, but is not limited to possessing only those elements or features. Likewise, a method that “comprises,” “has,” “includes” or “contains” one or more steps possesses those one or more steps, but is not limited to possessing only those one or more steps. Additionally, terms such as “first” and “second” are used only to differentiate structures or features, and not to limit the different structures or features to a particular order.

The terms “antenna,” “transmitter,” “receiver,” “waveguide,” and “transmission line” are used broadly throughout this disclosure to include a number of devices or technologies known to persons skilled in the design of electromagnetic devices. These terms are not necessarily mutually exclusive and may be used interchangeably herein. The use of any of the above terms should not be construed as necessarily limiting the specification or claims to one particular technology or device shape, dimensions, type of device, or set of physical properties.

The term “electronic device” (and any form of electronic device, such as “electronics,” and “electrical device”) are used broadly throughout this disclosure to include a number of devices or technologies known to persons skilled in the design of electromagnetic devices including, without limitation: transmitters, receivers, microwave devices, solid state devices, semiconductor devices, devices incorporating electrical components or carrying electrical charges, both passive and powered electronics devices, sensors and the like. Those skilled in the art will recognize many devices and components that may not be listed explicitly herein but which comprise the present invention.

The terms “microwave” and “electromagnetic signal” may be used, without limitation, to describe electromagnetic waves, electromagnetic signals, electronic signals, microwave frequencies, frequency ranges, mixed frequencies, carrier waves and the like. Use of the term “microwave” should not be construed as necessarily limiting frequencies to any particular ranges, or as limiting electromagnetic signal types unless otherwise specified herein.

The term “print” (and any form of print, such as “printed,” “printing,” and “prints”) is used broadly throughout this disclosure to include any technology that is, or may be used to form elements of the present devices and includes without limitation known circuit board, antenna and waveguide manufacturing techniques, in addition to known semiconductor manufacturing techniques, printing techniques, additive techniques (e.g., printing, adhesive techniques, screen printing, masking, vacuum deposition, electroplating, powder coating, extrusion, and sintering), subtractive techniques (e.g., milling, etching, cutting, ablation, erosion, and laser cutting), and other technologies known in the art.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

Further, a system (such as one of the present dielectric strap waveguide assemblies), a device (such as one of the present devices comprising at least a dielectric strap waveguide), or a component of a device that is configured in a certain way is configured in at least that way, but can also be configured in other ways than those specifically described.

### EXAMPLE 1

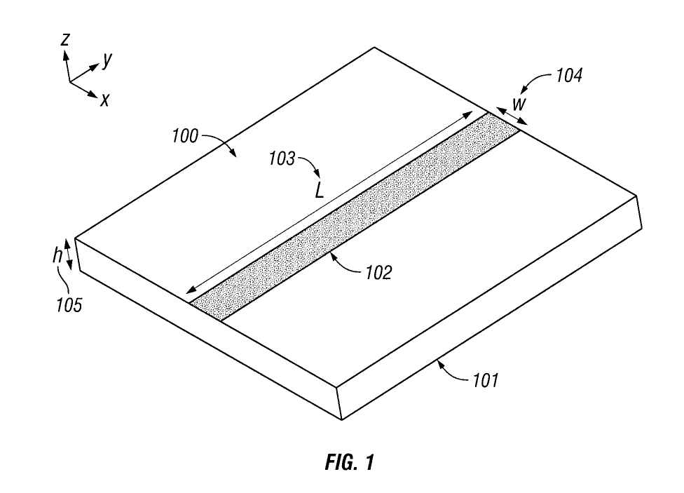

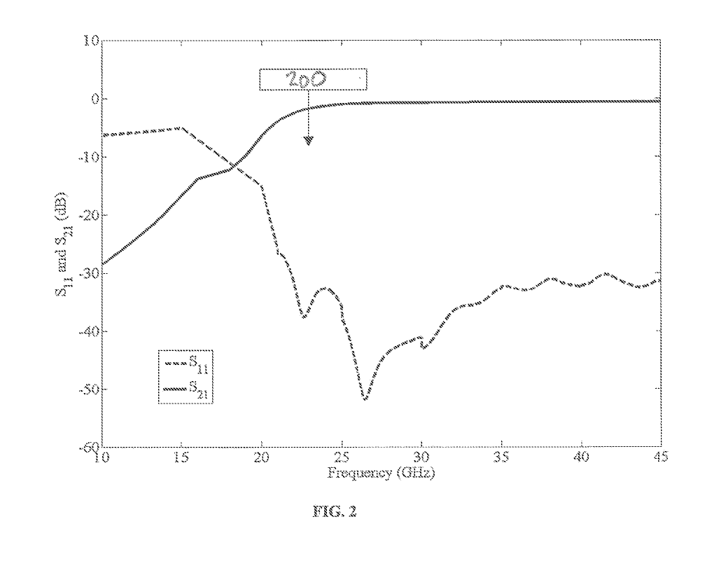

Referring now to the drawings, and more particularly to FIG. 1, shown therein and designated by the reference numeral 100 is one embodiment of the present Dielectric Strap Waveguide (DSW). The structure consists of a grounded dielectric substrate (101) on which a high-permittivity dielectric film (102) with a length (103), a width (104), and thickness t, is deposited (e.g., printed). The substrate (101) with thickness (105) should have low loss properties, with loss tangent of tan δ₁ and relative permittivity of ε₁. The permittivity and loss tangent of high-permittivity film are ε₂ and tan δ₂, respectively. FIG. 2 is a graph 200 representing the frequency response (S-parameters) of a waveguide with length (103) of 10 mm, width (104) of 1.2 mm, thickness (105) of 1 mm where ε₁=10.2, ε₂=300, tan δ₁=0.0023, tan δ₂=0.01, t=20 μm. This graph shows that the energy coupled into one end of the line (102) will be transmitted almost completely to the other end in frequencies higher than a certain frequency known as cutoff frequency demonstrating the low-loss properties of the waveguide above the cutoff frequency.

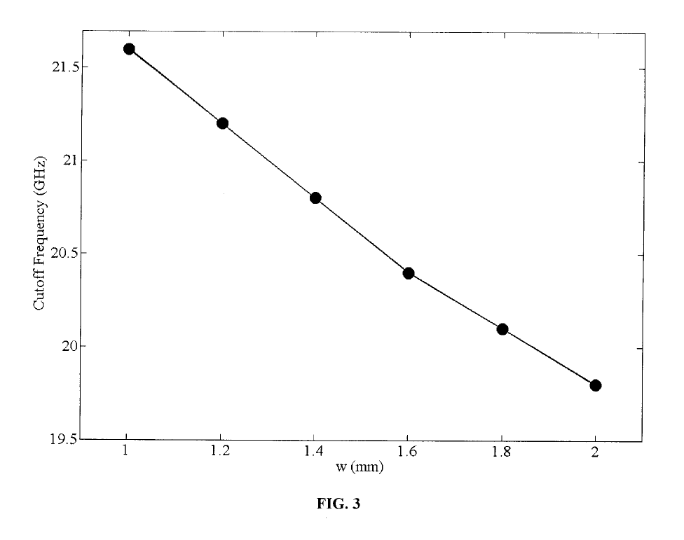

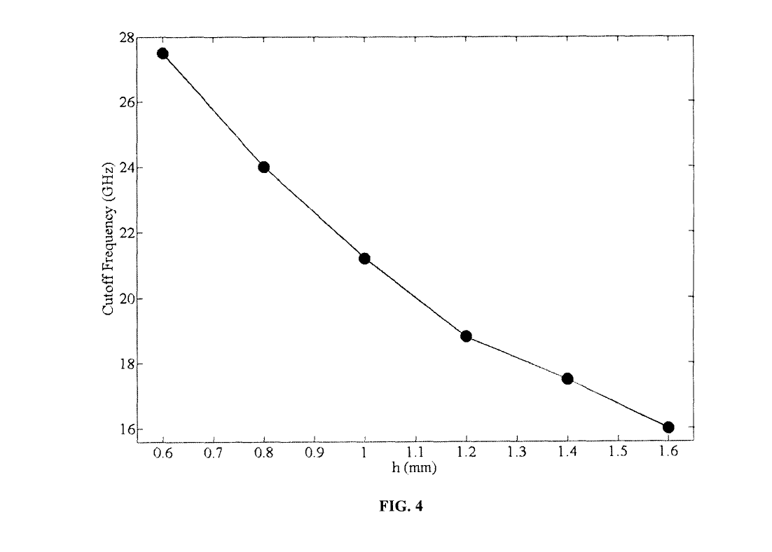

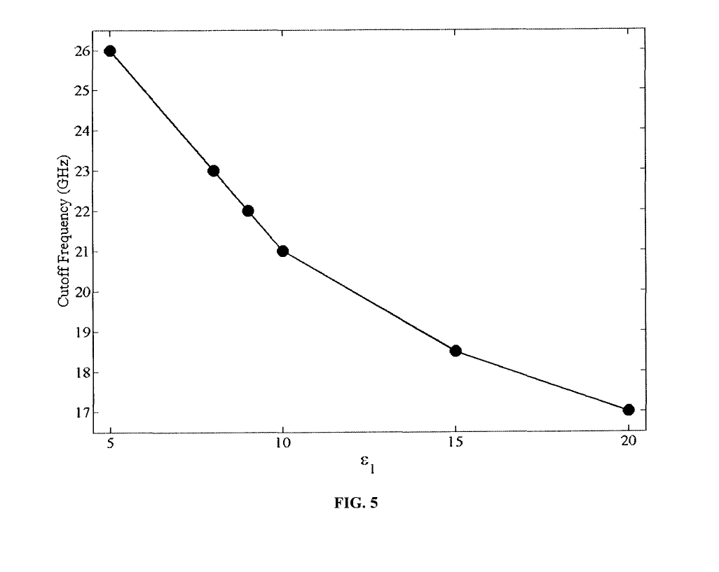

The cutoff frequency of an electromagnetic waveguide is an important parameter that presents the lowest frequency at which a given electromagnetic wave will propagate within the waveguide. The permittivity and thickness of the substrate and width of the high-permittivity film affect the cutoff frequency of the dielectric strap waveguide. FIGS. 3, 4, and 5 demonstrate varying cutoff frequencies with respect to these parameters. For example, FIG. 3 corresponds to a fixed thickness of 20 μm, height of 1 mm, ε₁=10.2, and ε₂=300, FIG. 4 corresponds to a fixed thickness of 20 μm, width of 1.2 mm, ε₁=10.2, and ε₂=300, and FIG. 5 corresponds to a fixed thickness of 20 μm, height of 1 mm, width of 1.2 mm, and ε₂=300. As illustrated in these figures, the permittivity and thickness of the substrate have a great impact on the cutoff frequency, confirming that the electromagnetic wave is guided through the dielectric substrate by reflections from the high-permittivity film.

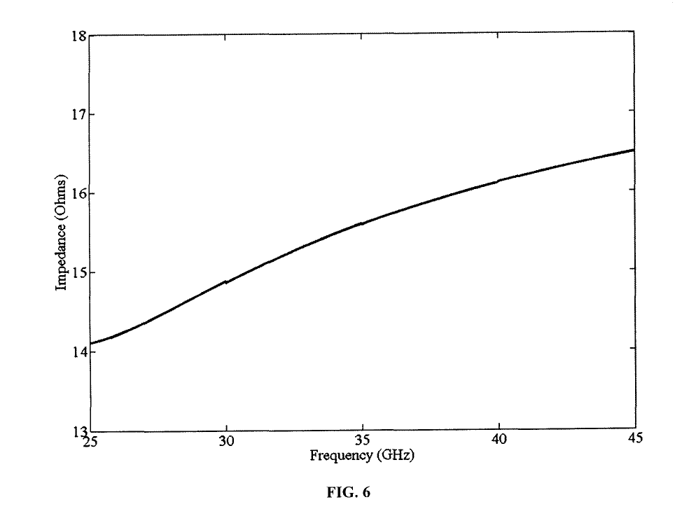

The characteristic impedance of an example DSW (with similar properties demonstrated for FIG. 2) is shown in FIG. 6, which presents values from 14 to 17 Ω corresponding to a DSW with length (103) of 10 mm, width (104) of 1.2 mm, thickness (105) of 1 mm where ε₁=10.2, Ε₂=300, tan δ₁=0.0023, tan δ₂=0.01, t=20 μm. Although impedance values of 14 to 17 Ω are illustrated in FIG. 6, a DSW according to embodiments of this disclosure with other permittivities and geometries may have other impedance values, such as between approximately 10 Ω and approximately 100 Ω. The characteristic impedance of a waveguide or transmission line is the ratio of the amplitudes of a single pair of voltage and current waves propagating along the line in the absence of reflections. When the DSW is used with other types of microwave structures, the characteristic impedance can be used to design transitions (impedance matching circuits) in order to maximize the power transfer. The transition may be printed by, for example, employing a printing technology with a metallic ink or performing lithographic patterning.

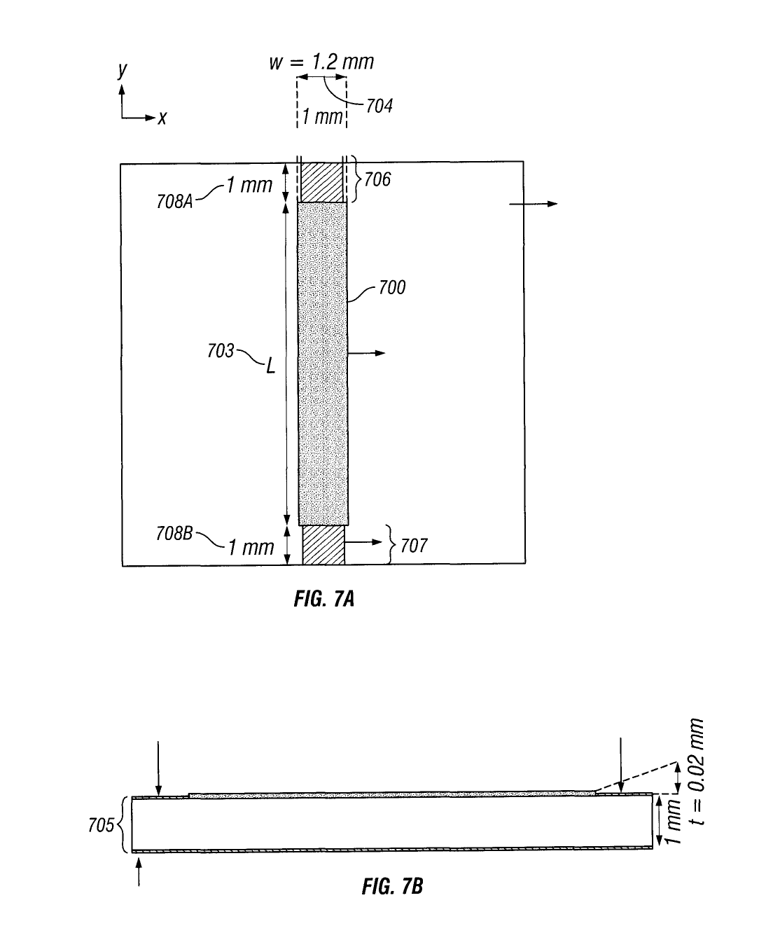

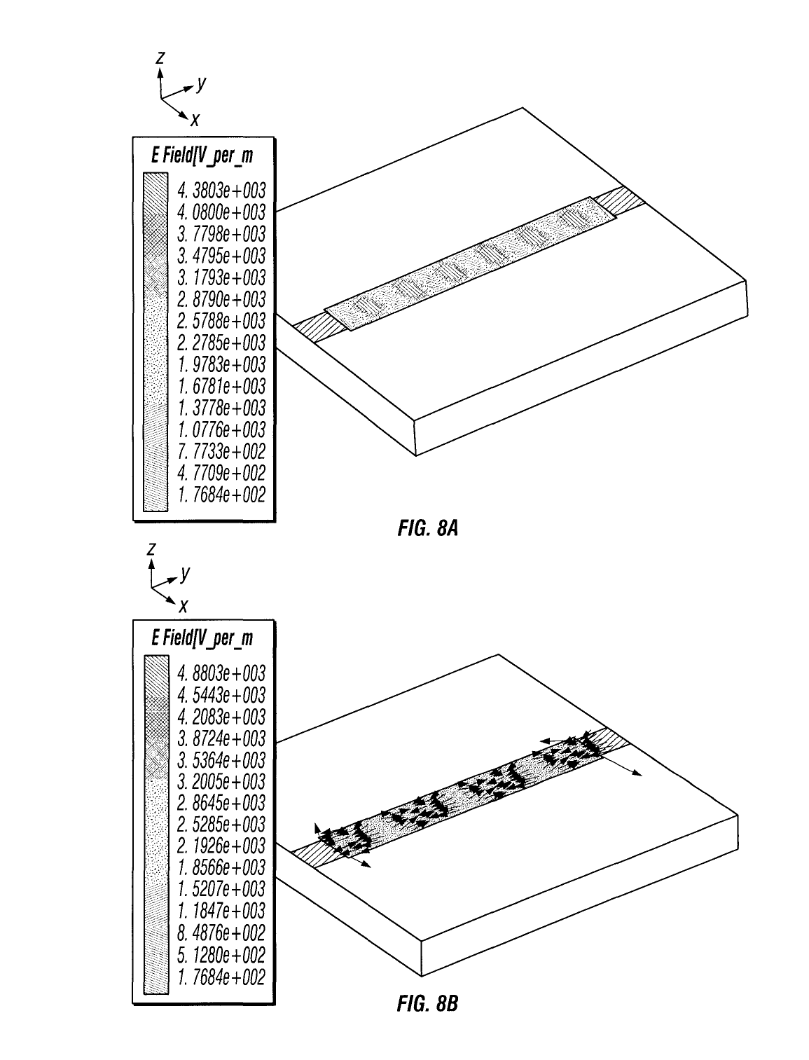

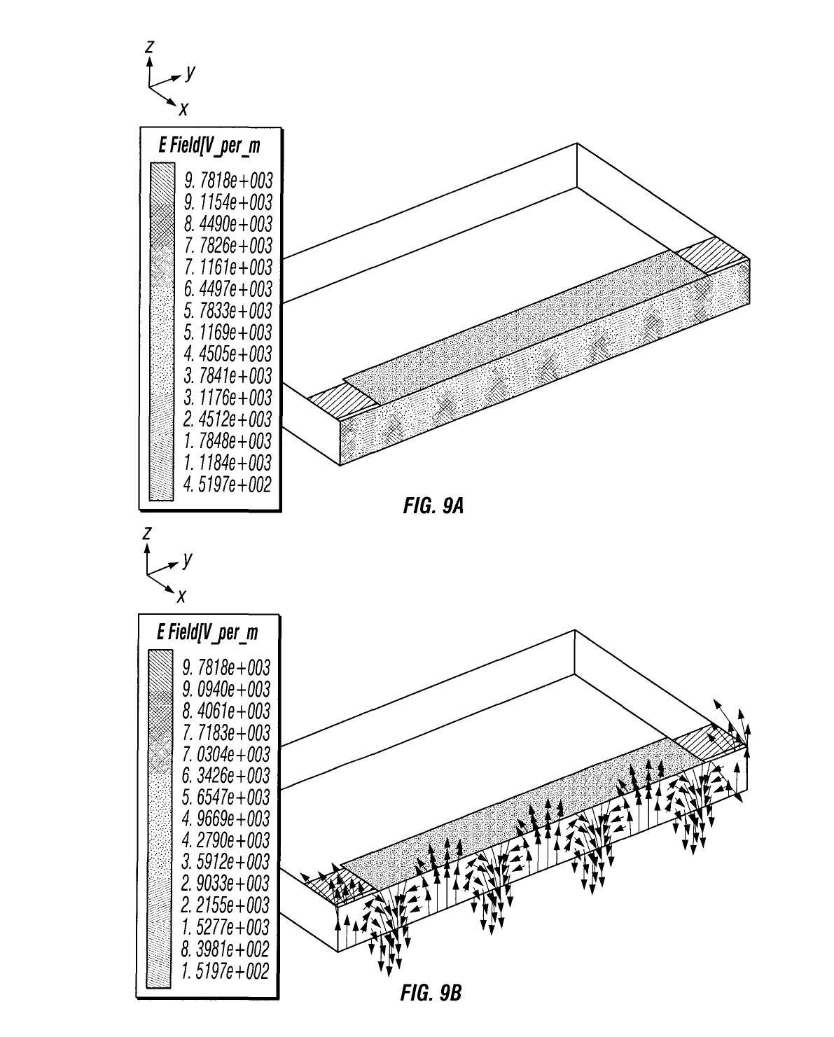

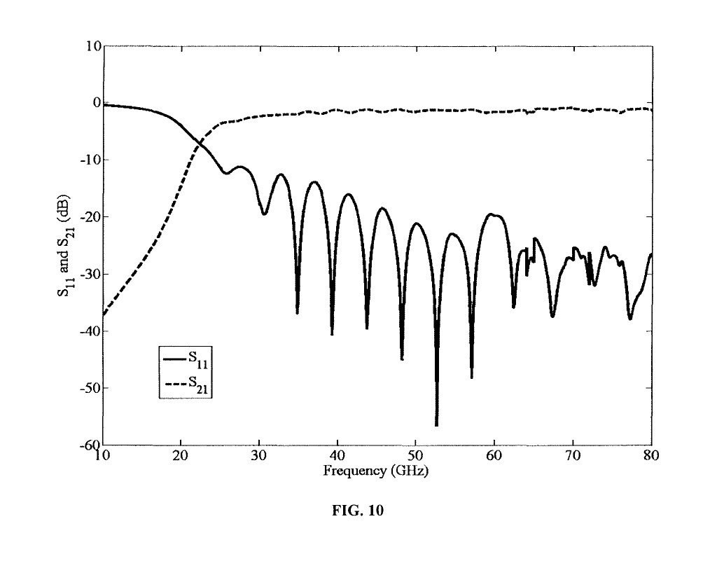

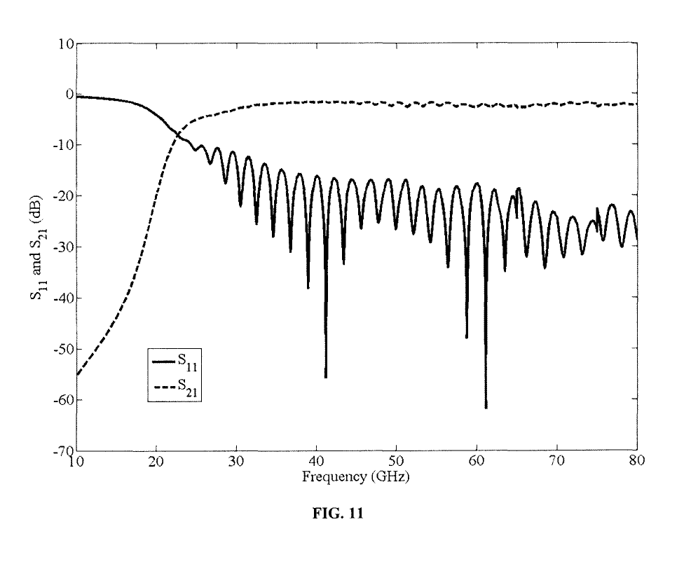

To derive properties of DSW, two microstrip line transitions (706), (707) are considered coupled to the input and output ports in the example shown in FIG. 7. These lines (706), (707) have a length (708A) and (708B) of 1 mm and are connected to a DSW (700) with variable length (703). In this example: width (704)=1.2 mm, thickness t=20 μm, height (705)=1 mm, ε₁=10.2, ε₂=300, tan δ₁=0.0023, tan δ₂=0.01. FIGS. 8A, 8B, 9A and 9B show the electric near-field vectors and intensities inside the DSW. The electric field is tangential to the high-permittivity film and perpendicular to the ground plane. The frequency response for the 8 mm and 18 mm DSW with two microstrip line transitions (706), (707) are shown in FIGS. 10 and 11, respectively. In the frequency band of 40 to 80 GHz, the return loss is around 20 dB while the insertion loss is in the range of a few decibels.

Inspection of the insertion loss at 60 GHz shows that it is 1.28 and 1.88 dB for the 8- and 18-mm DSWs, respectively, including the microstrip line transitions in the ports. The insertion loss contributed from the transition loss and the single DSW is estimated and the results are summarized in Table 1. The insertion loss for the DSW is 0.06 dB/mm, and the insertion loss for two transitions is 0.8 dB.

TABLE 1
Loss Characteristics of the DSW at 60 GHz

| Item | Loss | |
|---|---|---|
| 8 mm line with 2 transitions | 1.28 | dB |
| 18 mm line with 2 transitions | 1.88 | dB |
| Insertion loss for the line | 0.06 | dB/mm |
| Insertion loss for two transitions | 0.8 | dB |

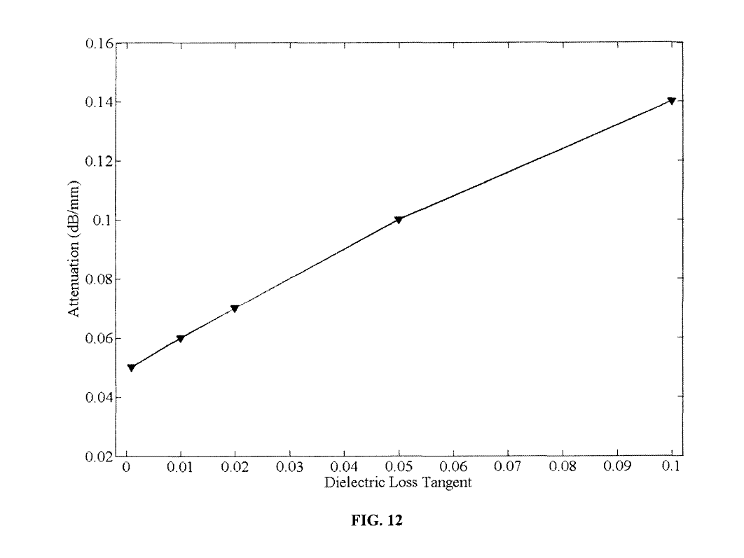

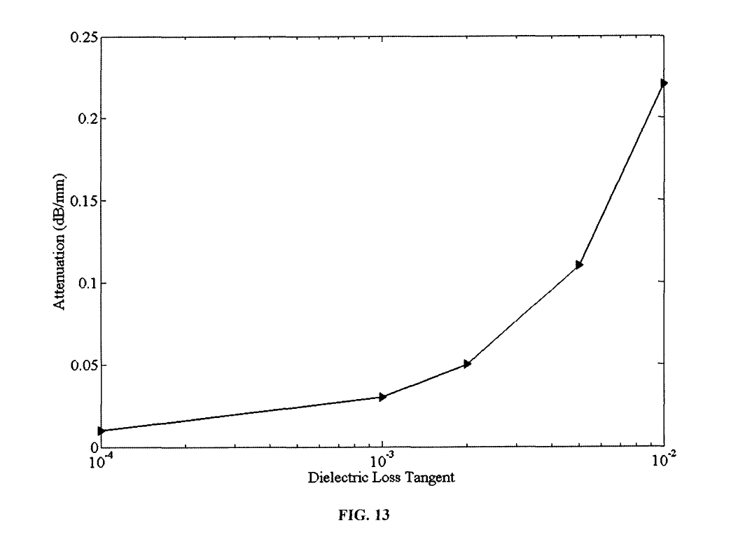

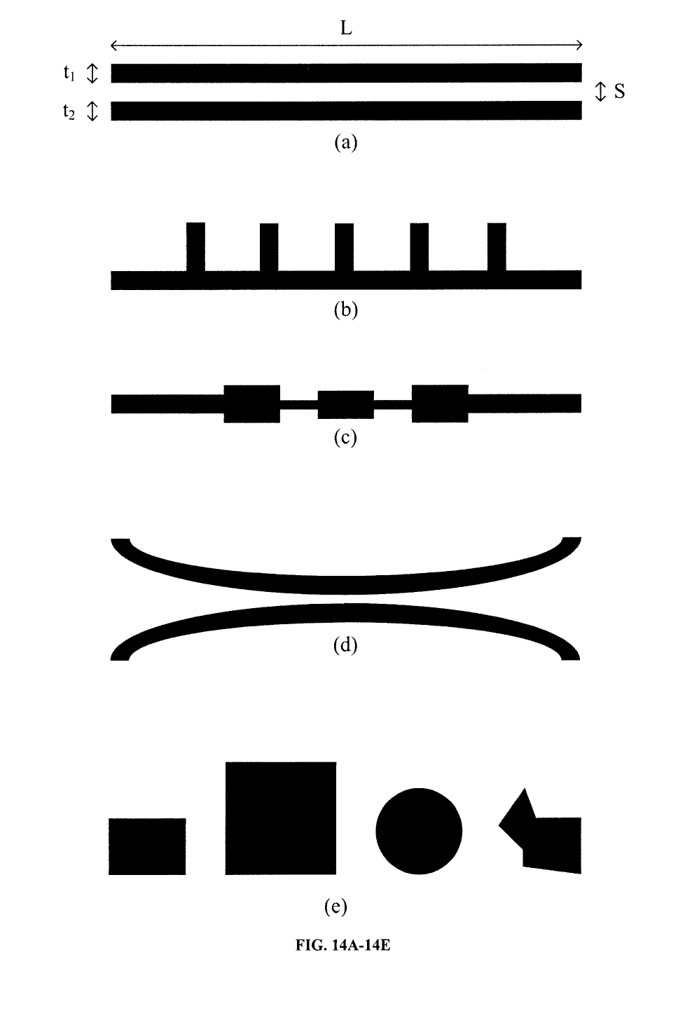

The electrical properties of the materials (i.e. permittivity and loss tangent) and thickness of the high-permittivity film will affect the results in different ways. For instance, Table 2 shows that by increasing the permittivity of the high-permittivity film from 150 to 1000 the insertion loss for the DSW and two transitions decreases and reaches 0.05 dB/mm and 0.43 dB, respectively. As the thickness of the high-permittivity film increases from 5 μm to 50 μm the insertion loss for the DSW and two transitions decreases, as reported in Table 3, and quantities of 0.05 dB/mm and 0.35 dB are observed, respectively. FIG. 12 shows that variations of the dielectric loss tangent of the high-permittivity film from tan δ₂=0.001 to 0.1 changes the insertion loss for the DSW in the range of 0.05 to 0.14 dB/mm. In comparison, changing the dielectric loss tangent of the substrate (i.e. tan δ₁) affects the insertion loss for the DSW significantly, as illustrated in FIG. 13. It is less than 0.01 dB/mm for tan δ₁=0.0001 and soars up to larger than 0.2 dB/mm for tan δ₁=0.01, reinforcing the importance of low-loss substrates to achieve high-efficient DSWs.

TABLE 2
Loss Characteristics of the DSW at 60 GHz as the Permittivity of the
Strap Changes, in which width (704) = 1.2 mm, thickness t = 20
μm, height (705) = 1 mm, ε₁ = 10.2, tan δ₁ = 0.0023, tan δ₂ = 0.01.

| | Loss for the | Loss for the | | |
|---|---|---|---|---|
| | short (8 mm) | long (18 mm) | | |
| | DSW with two | DSW with two | Insertion loss | Insertion loss for |
| | transitions | transitions | for the DSW | two transitions |
| ε₂ | (dB) | (dB) | (dB/mm) | (dB) |
| 150 | 1.92 | 3.02 | 0.11 | 1.04 |
| 300 | 1.28 | 1.88 | 0.06 | 0.80 |
| 600 | 0.99 | 1.53 | 0.05 | 0.56 |
| 1000 | 0.83 | 1.33 | 0.05 | 0.43 |

TABLE 3
Loss Characteristics of the DSW at 60 GHz as the Thickness of
the Strap Changes, in which width (704) = 1.2 mm, height (705) =
1 mm, ε₁ = 10.2, ε₂ = 300, tan δ₁ = 0.0023, tan δ₂ = 0.01.

| | Loss for the | Loss for the | | |
|---|---|---|---|---|
| | short (8 mm) | long (18 mm) | | |
| | DSW with two | DSW with two | Insertion loss | Insertion loss for |
| t | transitions | transitions | for the DSW | two transitions |
| (μm) | (dB) | (dB) | (dB/mm) | (dB) |
| 5 | 2.55 | 4.01 | 0.15 | 1.38 |
| 10 | 1.94 | 3.03 | 0.11 | 1.07 |
| 20 | 1.28 | 1.88 | 0.06 | 0.80 |
| 50 | 0.74 | 1.23 | 0.05 | 0.35 |
| 100 | 0.64 | 1.21 | 0.06 | 0.18 |
| 110 | 0.92 | 1.75 | 0.08 | 0.26 |

Any variation or discontinuity in the high-permittivity line/surface and/or changing the configuration can result in a new passive microwave devices or antenna elements. For instance, this can be in the form of identical or non-identical parallel lines or curves (FIG. 14(a) and (d)), periodic structures (FIG. 14(b)), discontinuity in the line (FIG. 14(c)), and any isolated shape such as circular, rectangular, and arbitrarily-shaped structures (FIG. 14(e)). The dielectric substrate can also include multi-layer structures or a variety of other configurations known in the art. Other representative embodiments may include other configurations, such as described below.

DSWs propagate waves in frequencies higher than a certain frequency (i.e. cutoff frequency). Therefore, in some embodiments, one or more DSWs may be considered a high-pass filter. By adjusting the size and the shape of the DSW(s) in some embodiments, other types of filters can be also realized.

### EXAMPLE 2

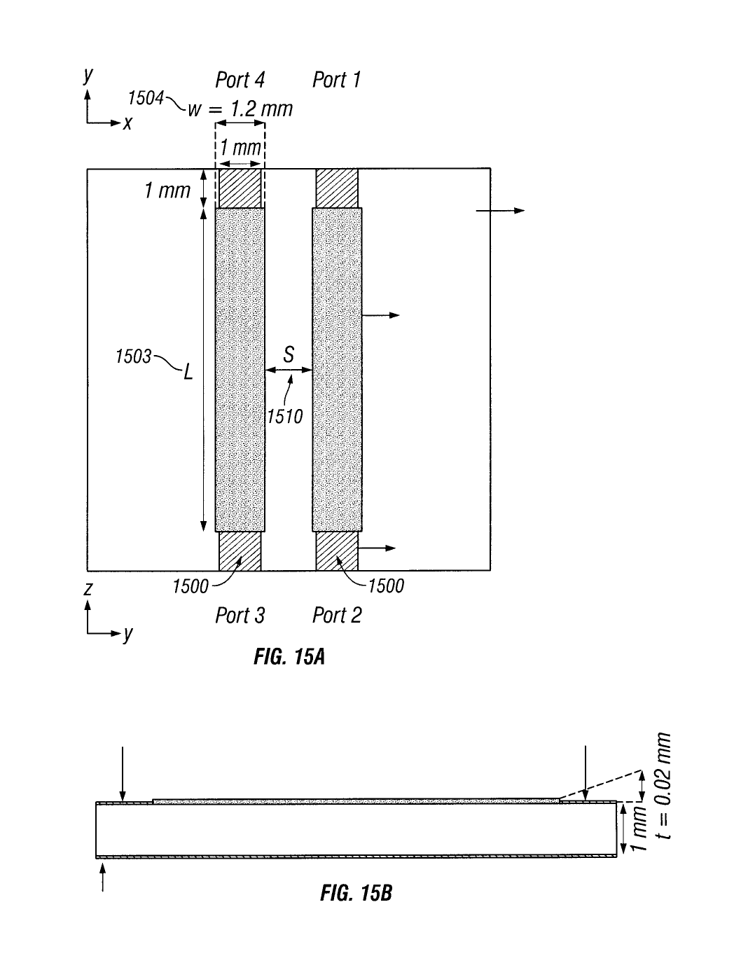

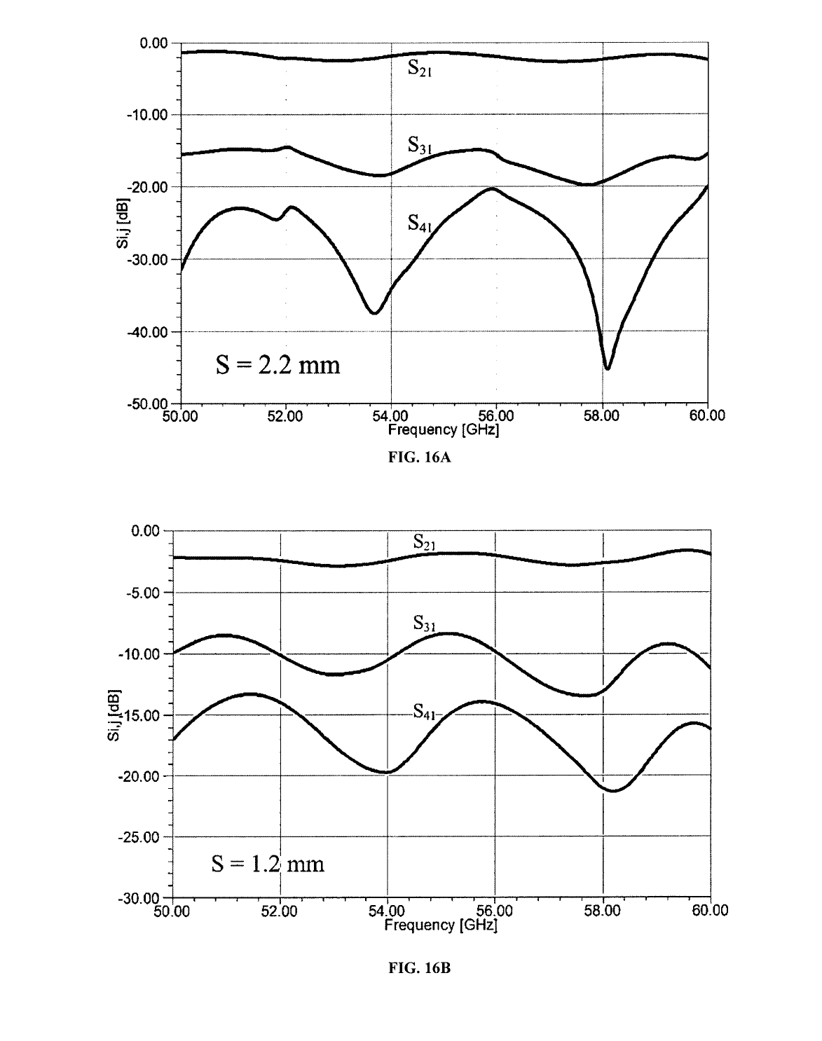

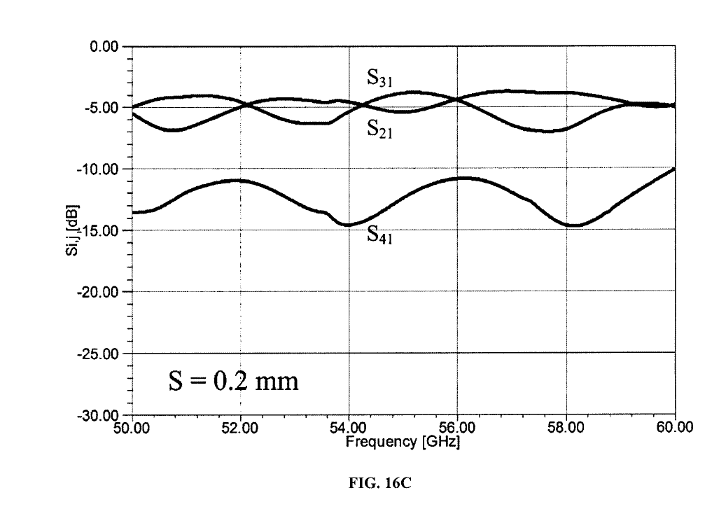

In another embodiment, a coupler or coupling device is another essential part of a microwave passive circuit or circuits. An exemplary embodiment of directional couplers, designed using identical parallel DSWs, is shown in FIG. 15. Ports 1-4 are labeled on FIG. 15 and illustrate an input port Port 1, a direct (through) port Port 2, a coupled port Port 3, and an isolated port Port 4. Although four ports and their corresponding functionalities are described with respect to FIG. 15, any number of ports may be included on the DSW and different functions may be assigned to different ports. Two lines are apart from each other by a distance (1510) and all other parameters are kept fixed: length (1503)=8 mm, width (1504)=1.2 mm, thickness t=20 μm, h=1 mm, ε₁=10.2, ε₂=300, tan δ₁=0.0023, tan δ₂=0.01. FIG. 16 shows that in this embodiment, the power propagated in one guide can be transferred to the other with the amount of coupling dependent on the distance (1510) between two DSWs (1500).

### EXAMPLE 3

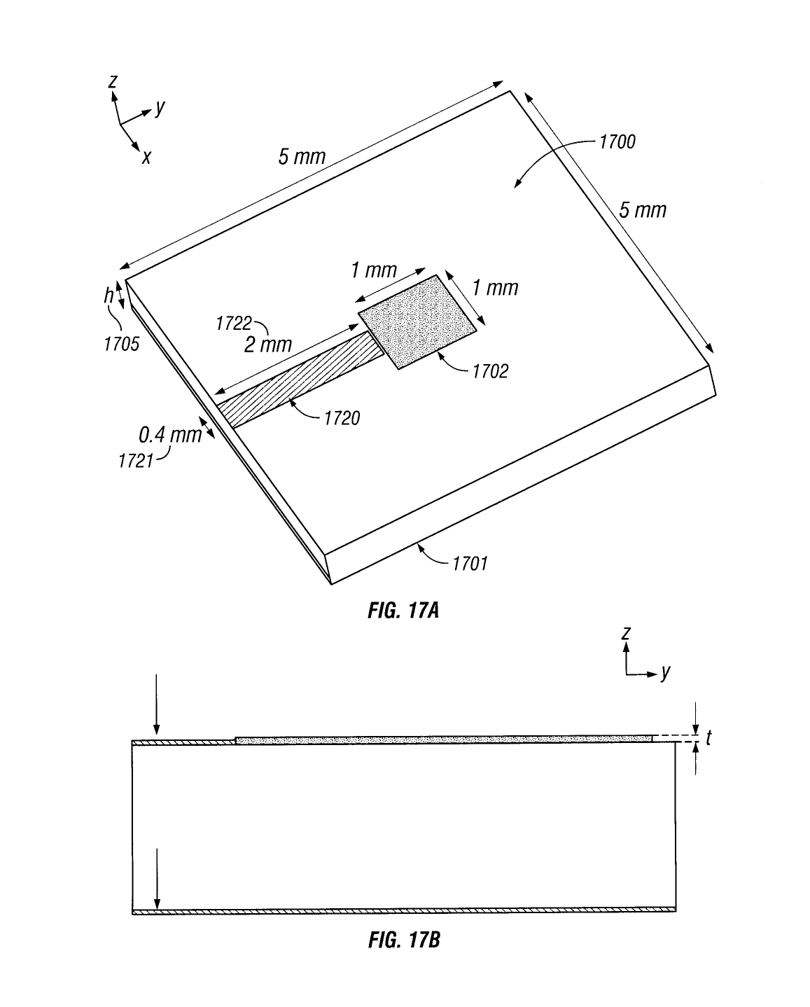

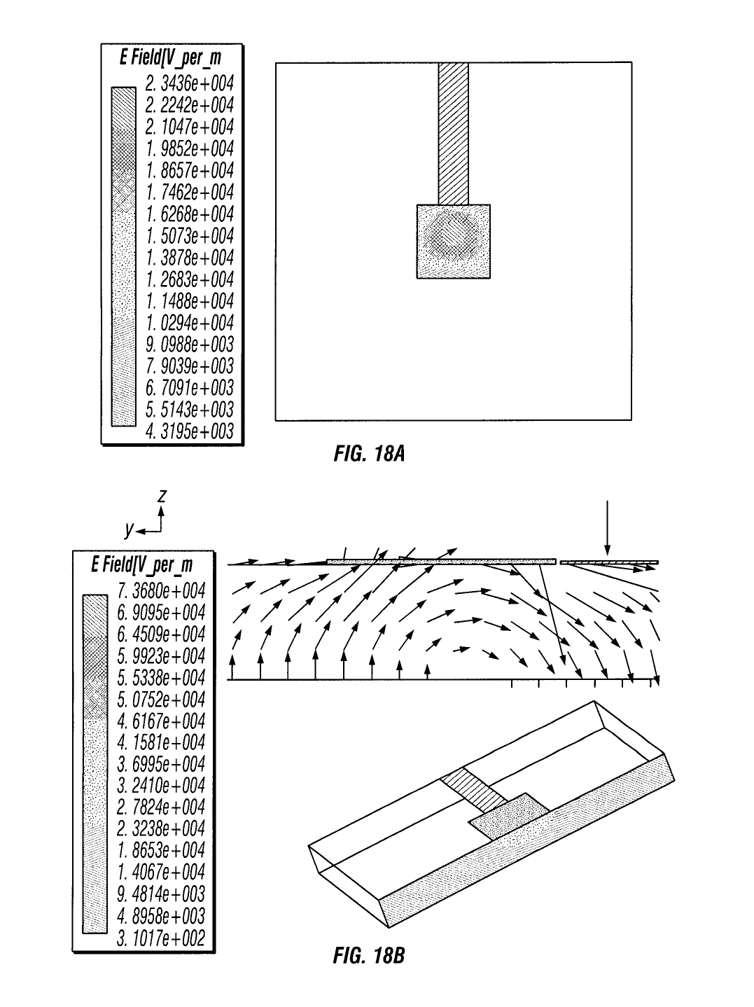

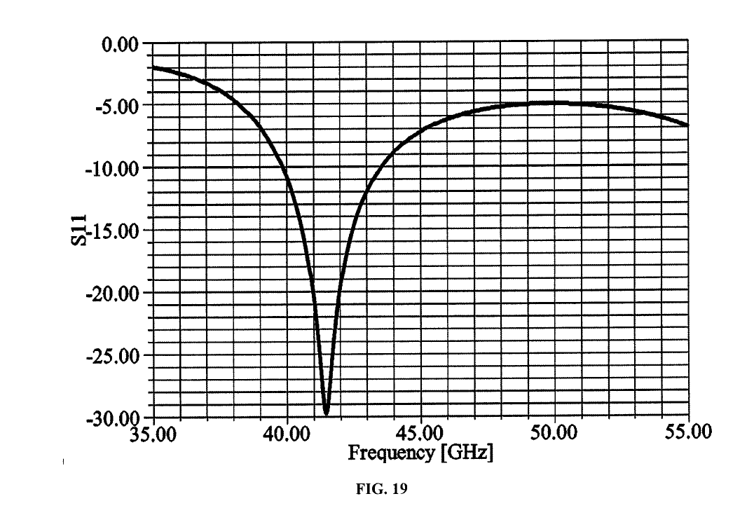

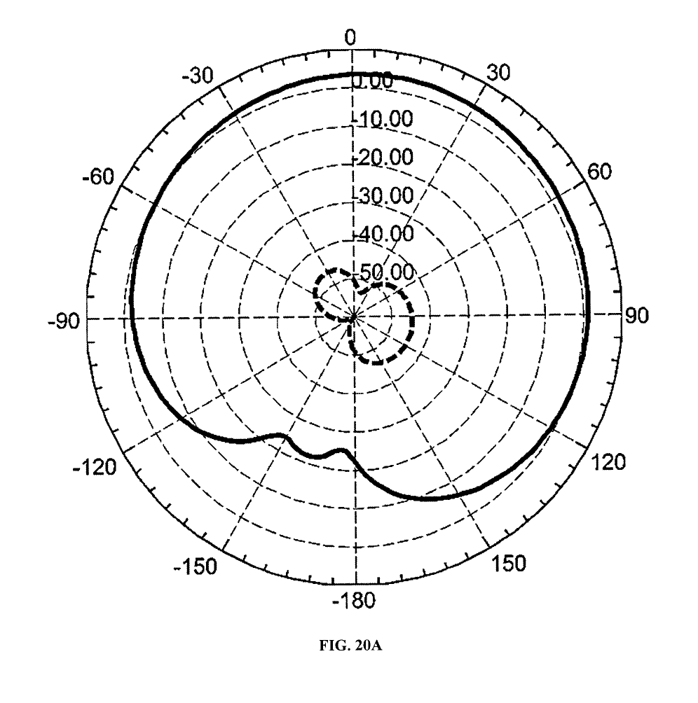

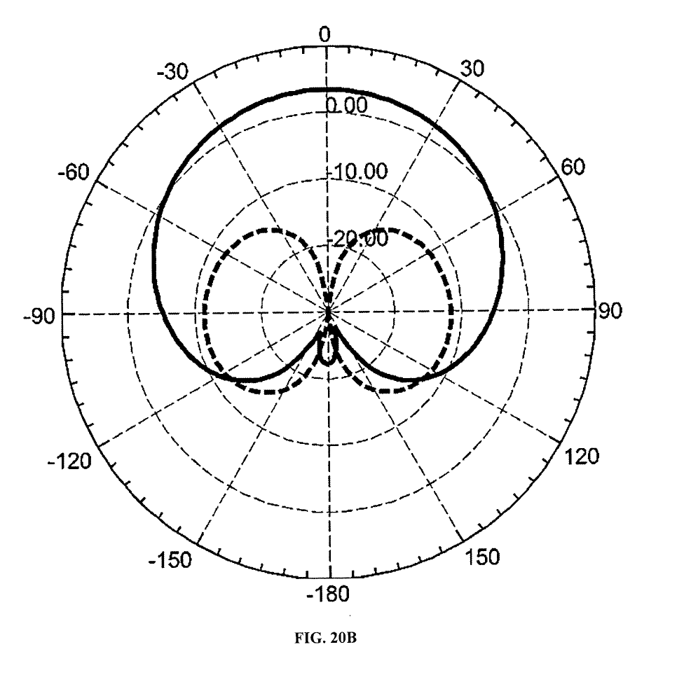

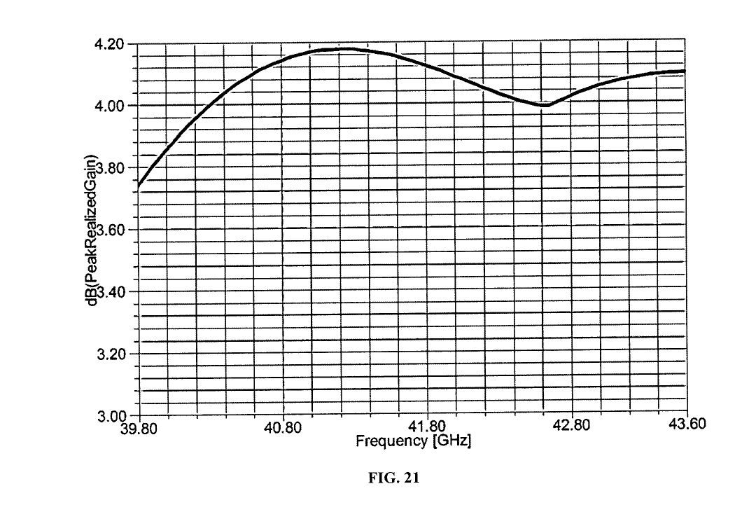

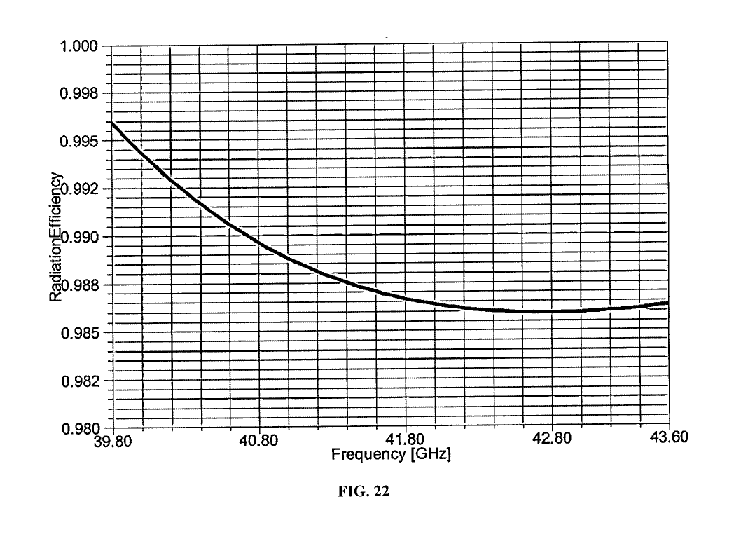

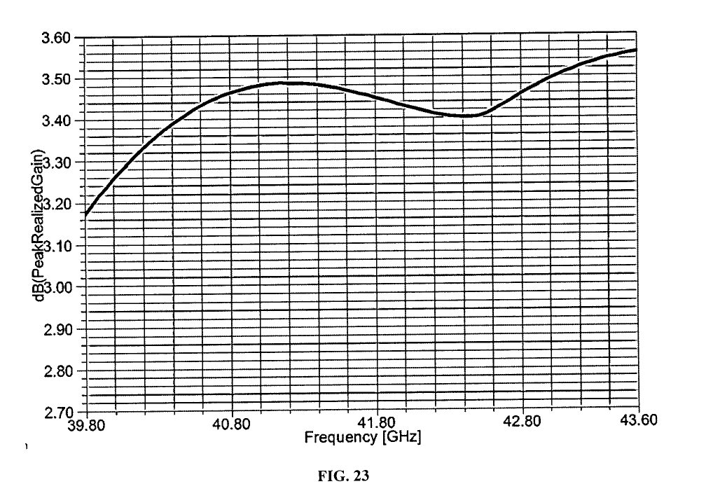

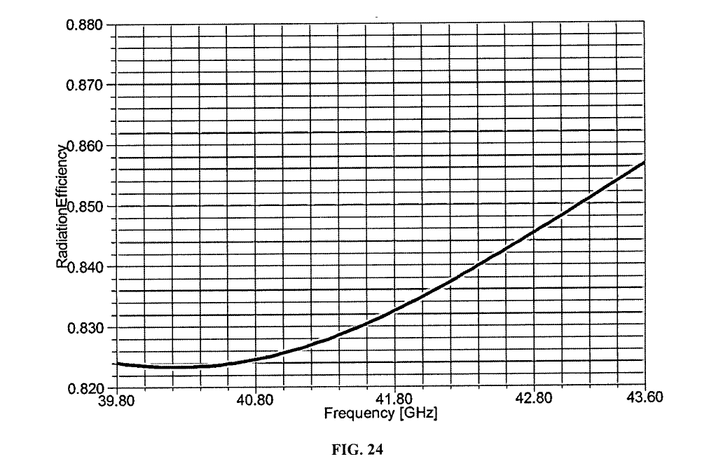

FIG. 17 shows another embodiment of a dielectric strap antenna (DSA) element. In this case the example antenna (1700) consists of a high-permittivity dielectric film (1702) with a square lateral topology (1 mm×1 mm) , thickness t=20 μm, height (1705)=0.5 mm, ε₁=10.2, ε₂=300, tan δ₁=0.0023, tan δ₂=0.01 implemented (e.g., printed) on a 5 mm square grounded substrate (1701). The excitation method in one embodiment is based on a proximity coupling using a 50 Ω metal microstrip transmission line (1720) with width (1721) of 0.4 mm and length (1722) of 2 mm. FIG. 18 shows the electric near-field distributions of this embodiment. The results are consistent with DSWs, demonstrating electric field vectors tangential to the high-permittivity film and perpendicular to the ground plane. As shown in FIG. 19, this embodiment of a DSA demonstrates a good performance from 39.8 to 43.6 GHz, equivalent to 9% impedance bandwidth (S₁₁≦−10 dB). The radiation patterns of the antenna are shown in FIG. 20. The DSA of this embodiment radiates in the broadside direction. The antenna gain and radiation efficiency versus frequency are shown in FIGS. 21 and 22, respectively. The antenna gain is around 4 dBi and the efficiency is above 98.5%. As the dielectric loss for the high-permittivity film increases to tan δ₂=0.1, antenna gain and radiation efficiency decreases (FIGS. 23 and 24). However, the radiation efficiency is still higher than 82% at 40 GHz frequency band.

### EXAMPLE 4

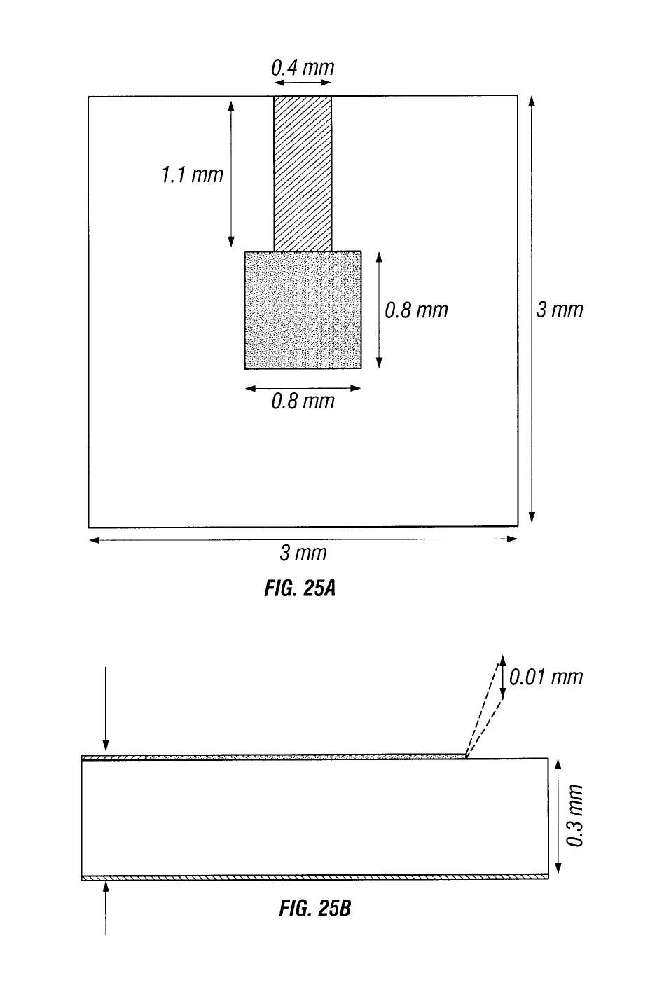

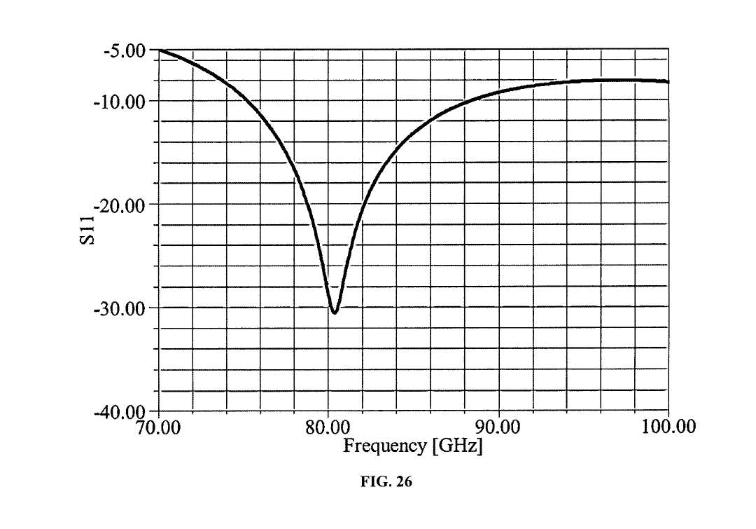

In a further embodiment, a DSA may have small dimensions as depicted in FIG. 25. Electrical properties of the materials in one embodiment are: ε₁=6.5, ε₂=200, tan δ₁=0.001, tan δ₂=0.1. The antenna operates in a higher frequency band that of the embodiment depicted in FIG. 17 as illustrated in FIG. 26, demonstrating 16% impedance bandwidth (S₁₁≦−10 dB) from 75 to 88 GHz.

### EXAMPLE 5

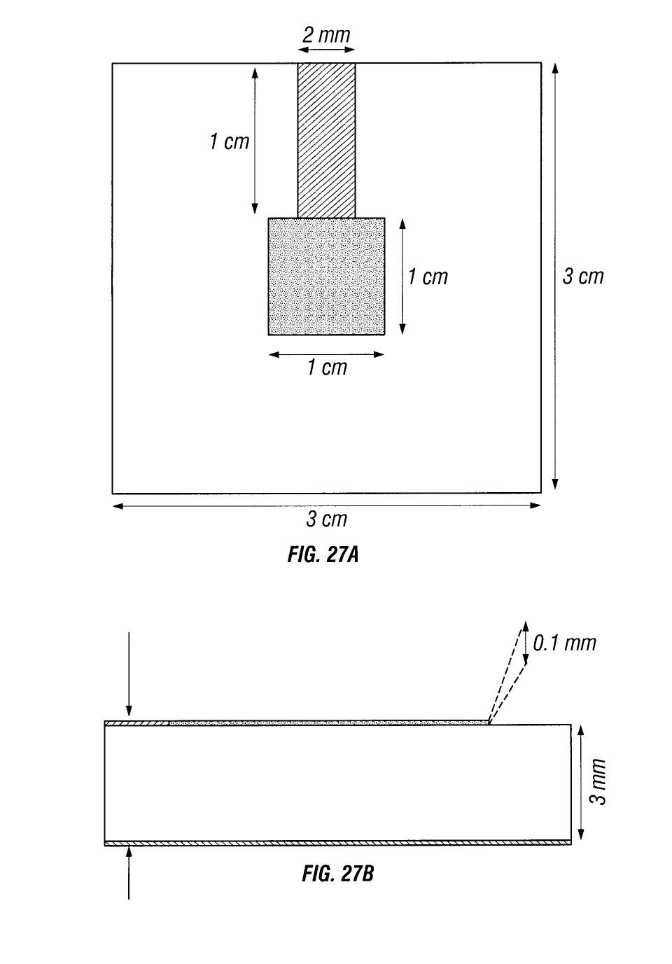

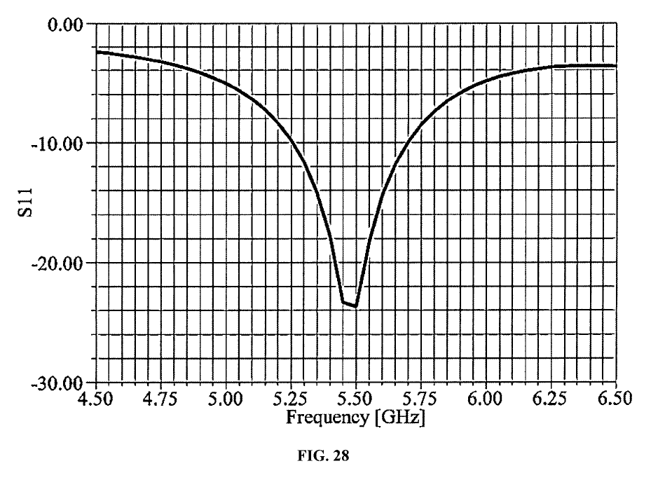

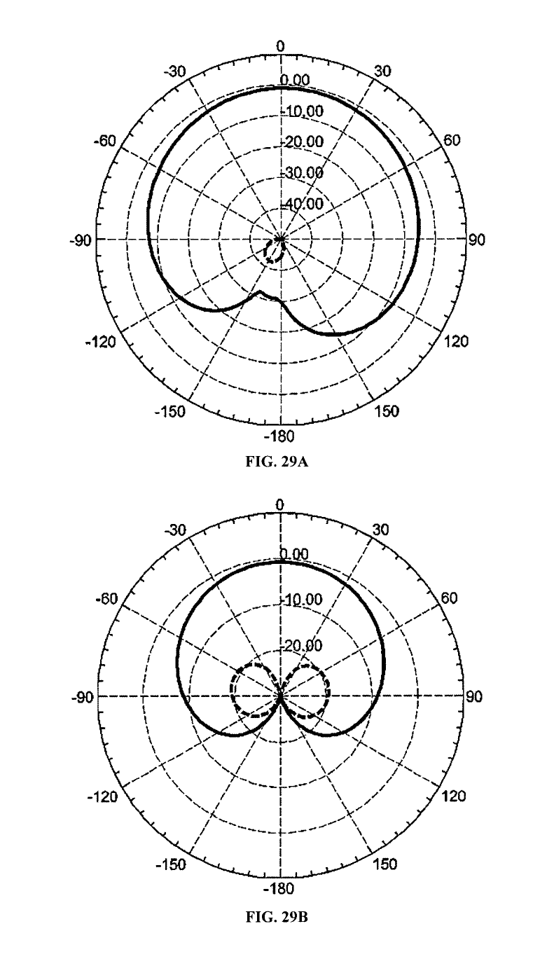

In a yet further embodiment, a DSA may have larger dimensions as depicted in FIG. 27. Electrical properties of the materials in one embodiment may be: ε₁=12, ε₂=400, tan δ1=0.001, tan δ₂=0.1. As shown in FIG. 28 the antenna of this embodiment demonstrates a performance from 5.2 to 5.7 GHz, equivalent to 9% impedance bandwidth (S₁₁≦−10 dB). The normalized radiation patterns shown in FIG. 29 are quite symmetrical with respect to the broadside direction and demonstrate lower cross polarization levels (with respect to those of FIG. 20) mostly due to the substrate with higher permittivity. The gain and radiation efficiency performance of the antenna follows similar trends as those discussed in the first antenna example. It should be noted that the loss tangent of the high-permittivity film at frequencies below 10 GHz can be considered better than tan δ₂=0.01, resulting in efficiencies that may exceed 99%.

### EXAMPLE 6

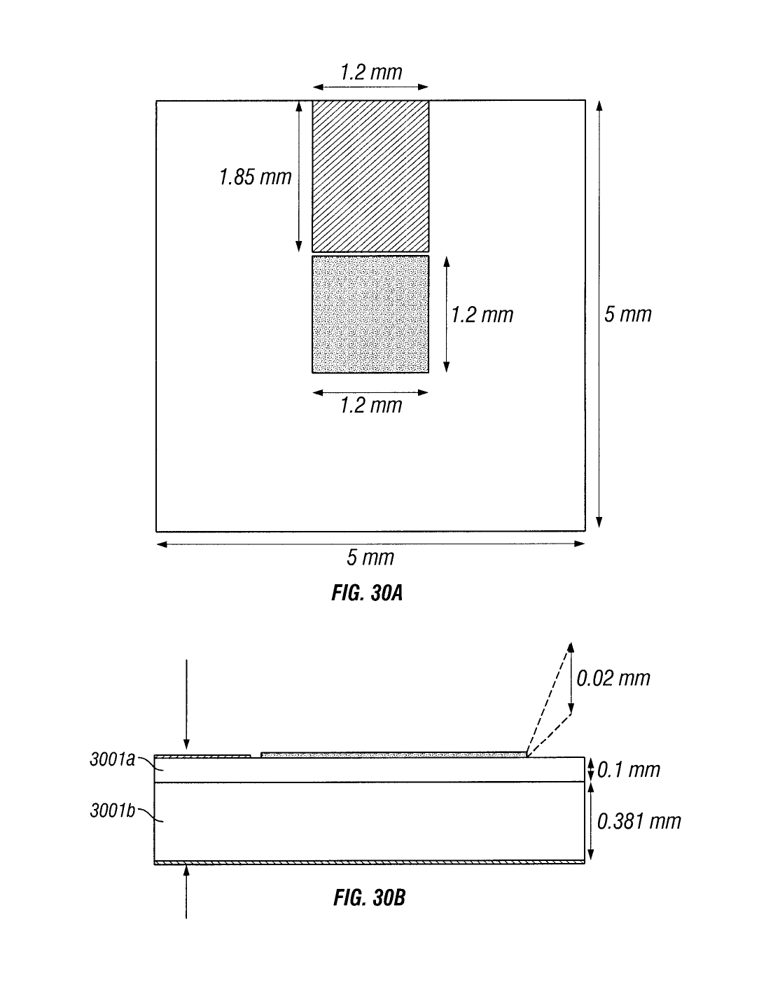

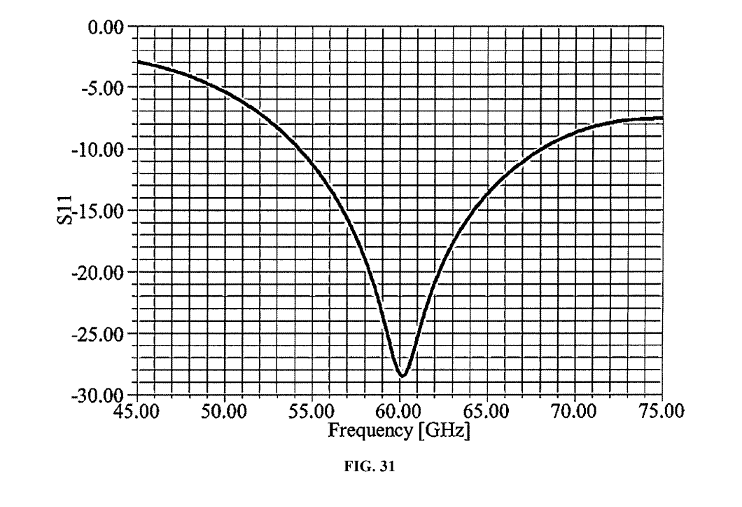

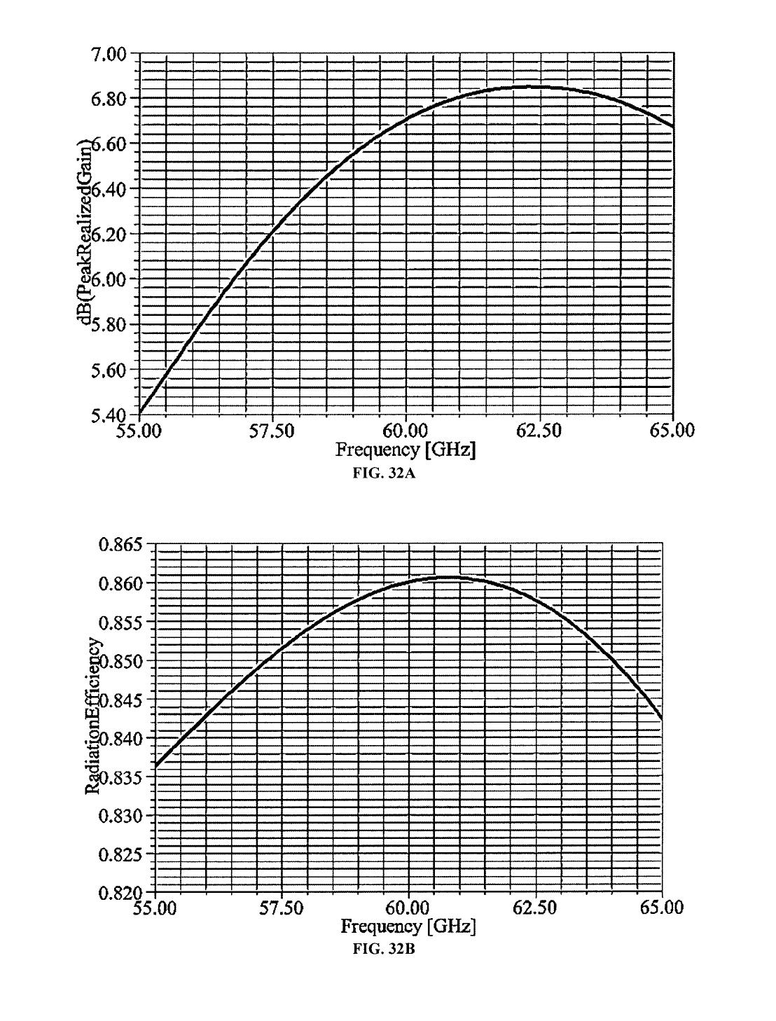

In some embodiments, the dielectric substrate may be a multi-layer structure. In the embodiment depicted in FIG. 30, the first substrate (3001a) (ε=10.2; tan δ=0.0023) with the thickness of 0.1 mm is supported by a second substrate (3001b) (ε=2.2; tan δ=0.001) with the thickness of 0.381 mm. The relative permittivity and loss tangent of the high-permittivity film are considered to be 150 and 0.1, respectively. As shown in FIG. 31 the DSA demonstrates a performance from 54 to 68 GHz, equivalent to 23% impedance bandwidth (S₁₁≦−10 dB). The normalized radiation patterns are similar to those of described for the embodiment depicted in FIG. 17. The gain and radiation efficiency of the antenna are shown in FIG. 32. The gain is around 6 dBi (2 dB improved) and the efficiency is around 85%. These values can be further improved if lower loss tangent is considered for the high-permittivity film.

### EXAMPLE 7

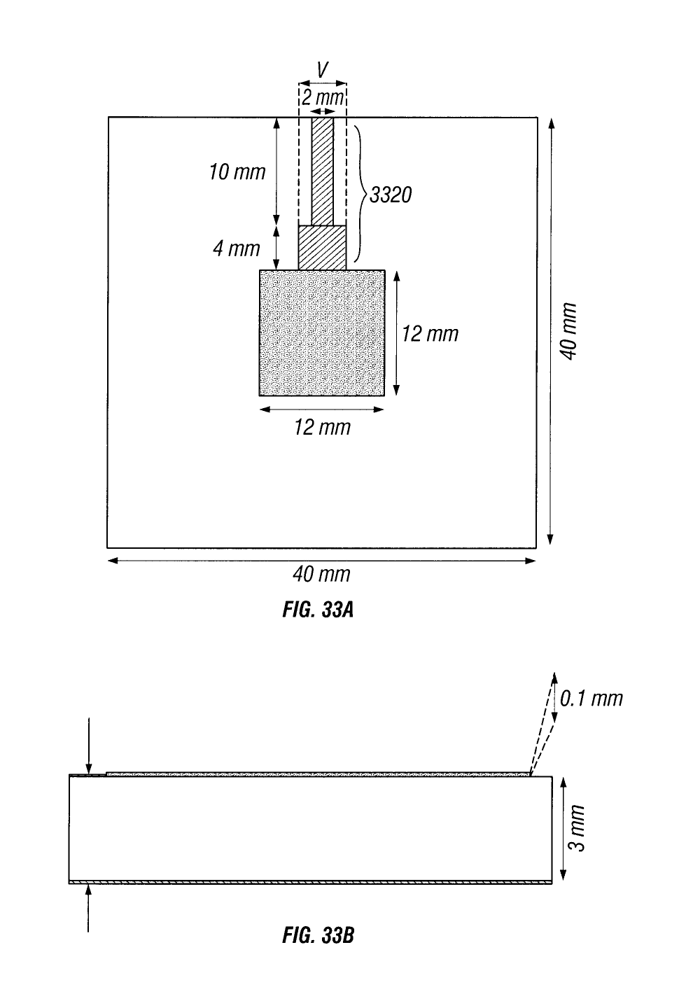

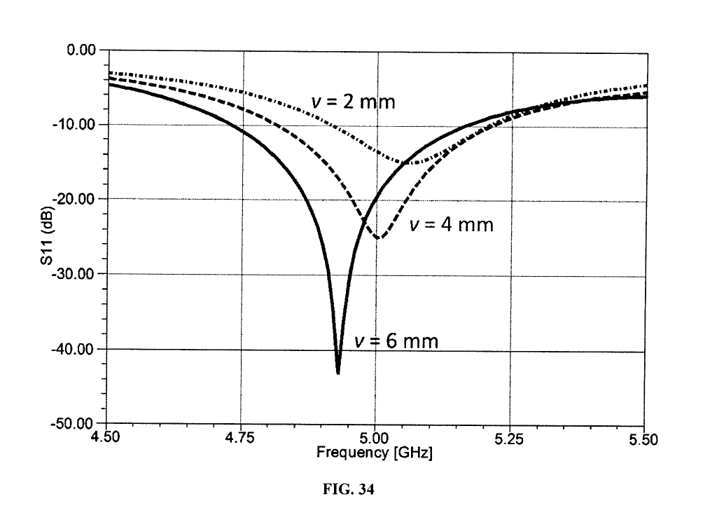

In further embodiments, different excitation methods can be used for the DSA. This can include microstrip, coplanar waveguide (CPW), slot, and probe methods as well as variations of the shapes used for excitation in these methods. In still further embodiments, different DSW waveguide excitation methods may be employed, such as when the DSW and the DSA devices may be realized in a common dielectric layer or in multiple layers. In the example shown in FIG. 33, the 50 Ω microstrip line (3320) is modified to increase the coupling level. Electrical properties of the materials are assumed to be: ε₁=12, ε₂=400, tan δ₁=0.001, tan δ₂=0.1. The results are shown in FIG. 34.

### EXAMPLE 8

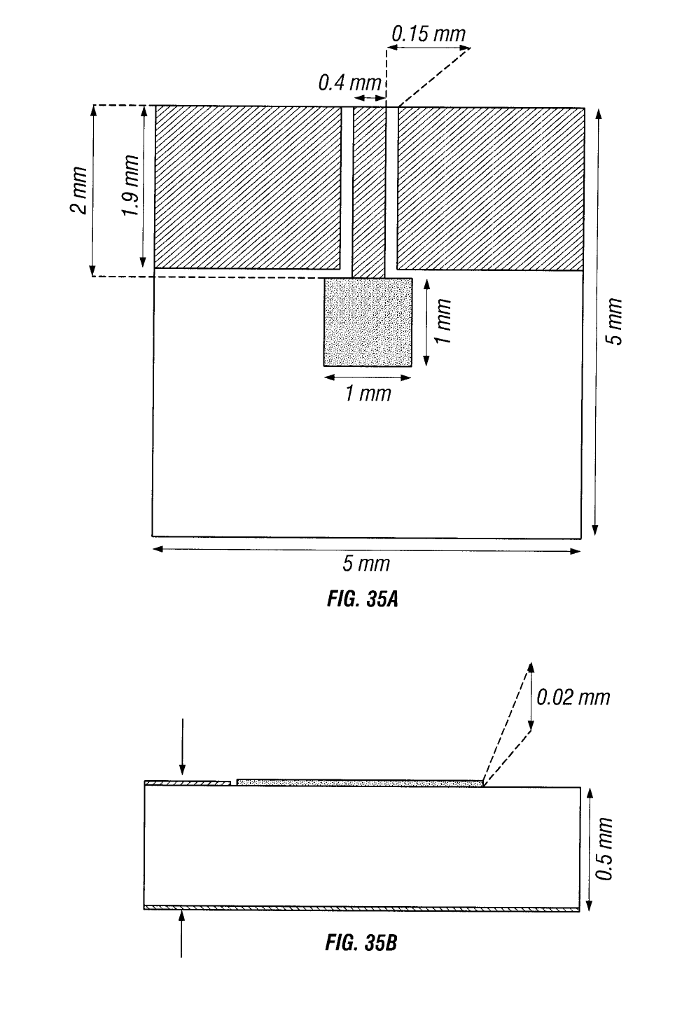

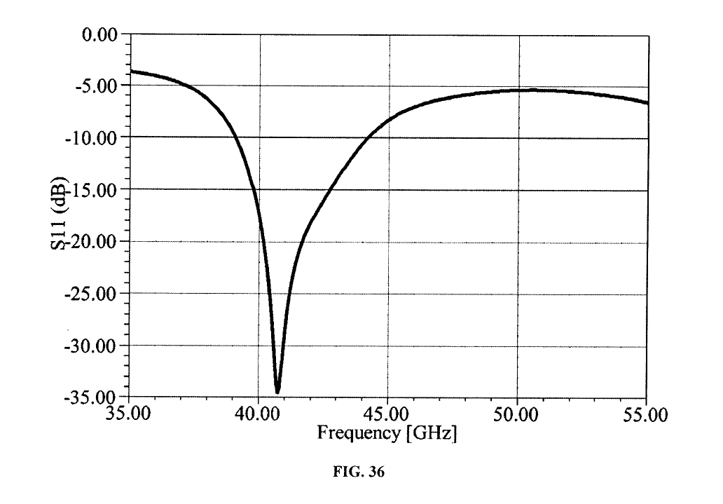

In FIG. 35, an embodiment of a DSA is excited by a CPW excitation method. This method can facilitate antenna testing at very high frequencies. The electrical properties of the materials are assumed to be: ε₁=10.2, ε₂=300, tan δ₁=0.0023, tan δ₂=0.01. The reflection coefficient of the antenna is shown in FIG. 36. The antenna radiation patterns, gain, and efficiency are similar to those of the previous examples.

### EXAMPLE 9

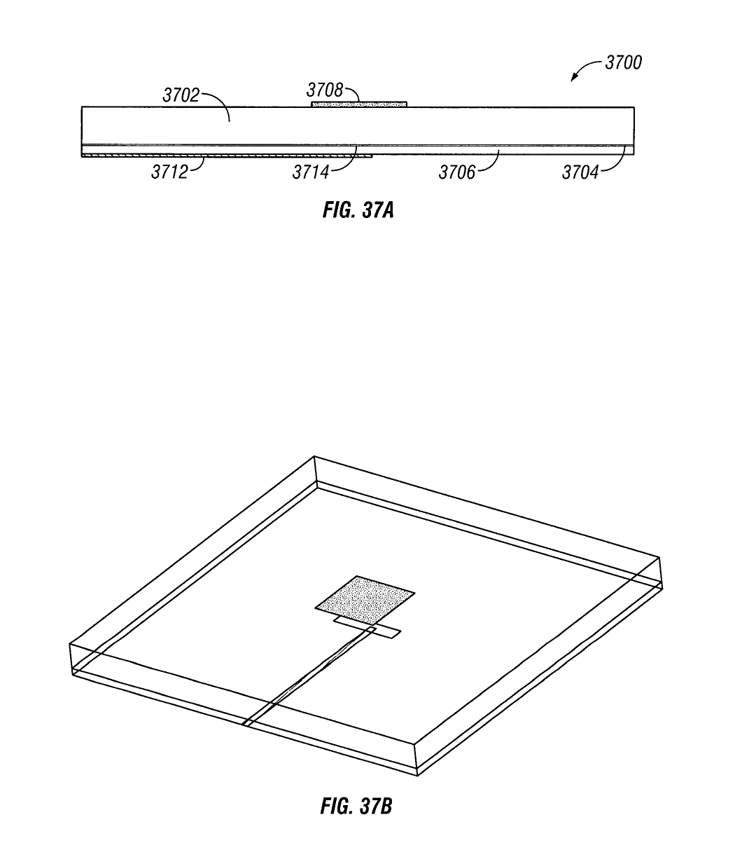

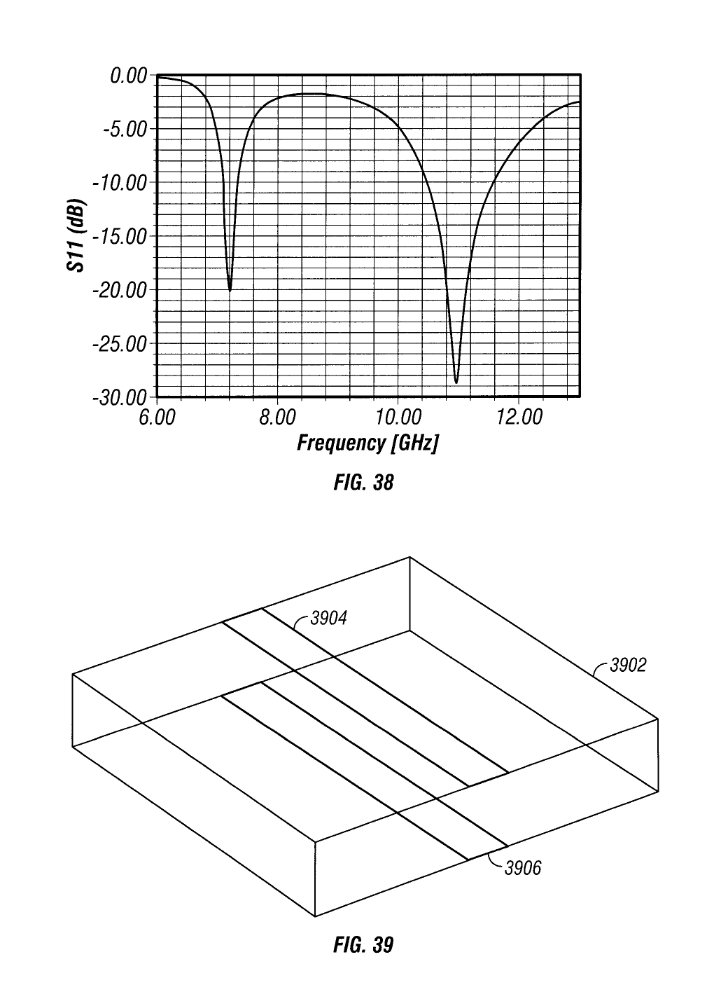

In FIG. 37, an embodiment of a DSA is excited by a slot excitation method. A DSA 3700 may include a first substrate 3702 on a ground plane 3704 of a second substrate 3706. In one embodiment, metallic layers may be located between the first substrate 3702 and the second substrate 3706. A high-permittivity film 3708 may be printed on the first substrate 3702. A microstrip line 3712 and a slot 3714 may be on an opposite side of the first substrate 3702 from the high-permittivity film 3708. The slot is 1 mm by 5 mm. The first and second substrate have εᵣ=10 and tan δ=0.0023. In one example, a 50 Ω microstrip line is 15.7 mm long and 0.5 mm wide, and the dimensions of the high-permittivity films are 5 mm by 5 mm with a thickness of 0.1 mm. The electrical properties of the film may be ε₂=300 and tan δ₂=0.01. The reflection coefficient of the antenna is shown in FIG. 38.

### EXAMPLE 10

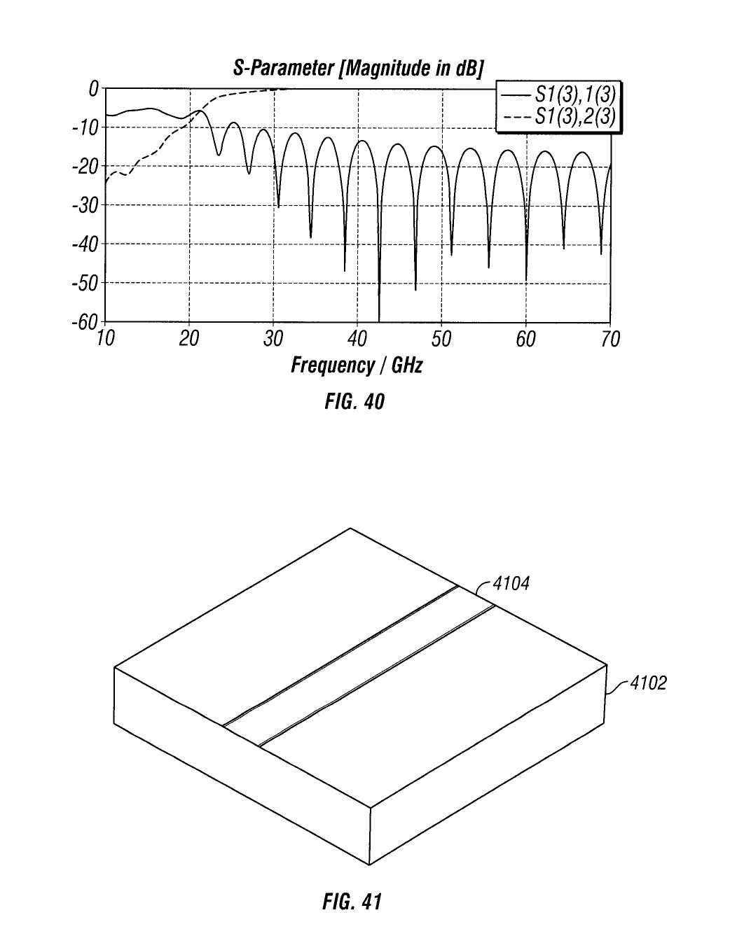

FIG. 39 shows another embodiment of DSW having two parallel dielectric straps 3904 and 3906 printed on a top and a bottom side, respectively, of a substrate 3902. FIG. 40 is a graph representing the frequency response (S-parameters) of the waveguide with length of 10 mm, width of 1.2 mm, thickness of 2 mm where ε₁=10.2, ε₂=300, tan δ₁=0.0023, tan δ₂=0.01, t=20 μm. This graph shows that the energy coupled into one end of the line will be transmitted almost completely to the other end in frequencies higher than cutoff frequency, demonstrating the low-loss properties of the waveguide above the cutoff frequency.

In one embodiment of the DSW of FIG. 39, no metallic components may be involved, which eliminates metal loss in the DSW structure. This allows for a simplified fabrication process and allow the construction of flexible electronic devices.

### EXAMPLE 11

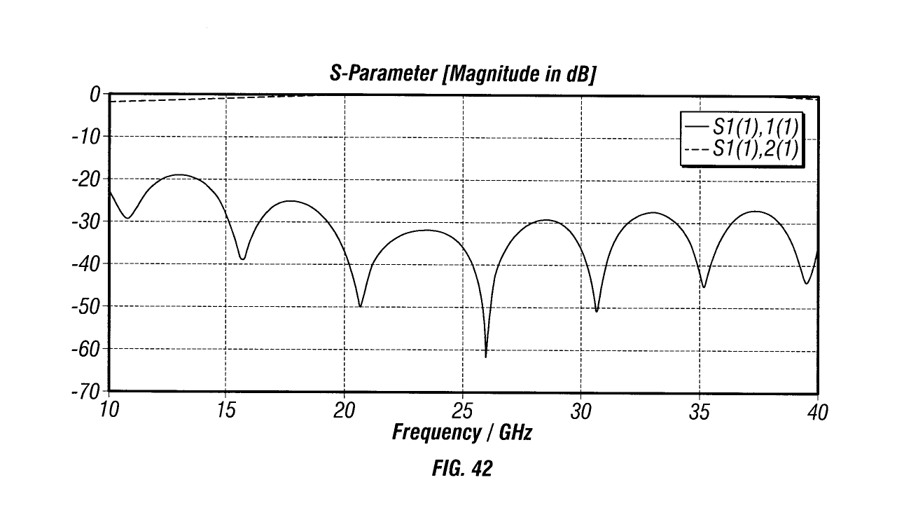

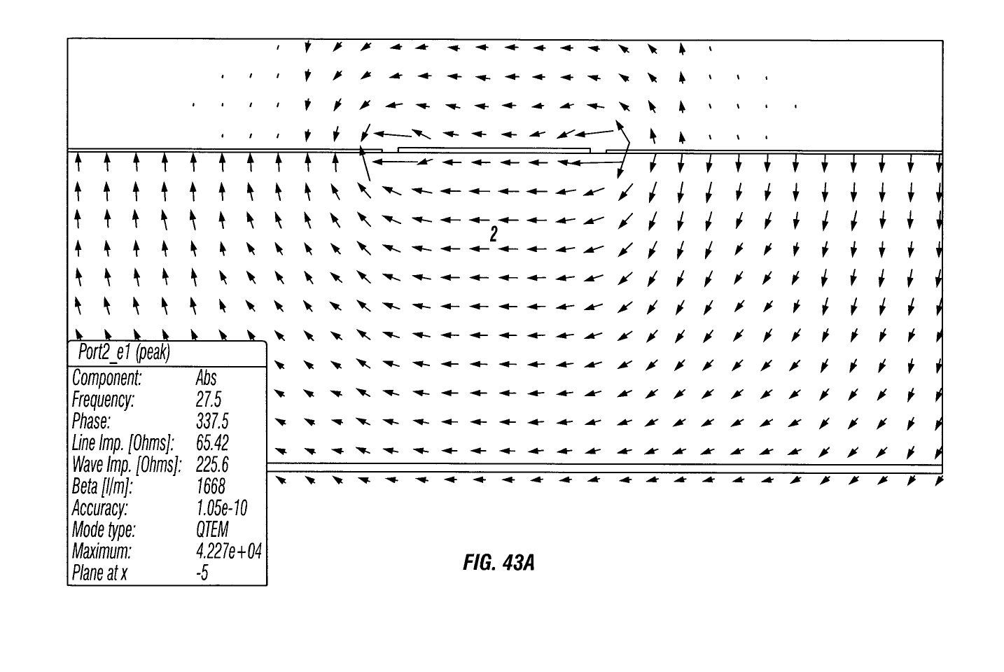

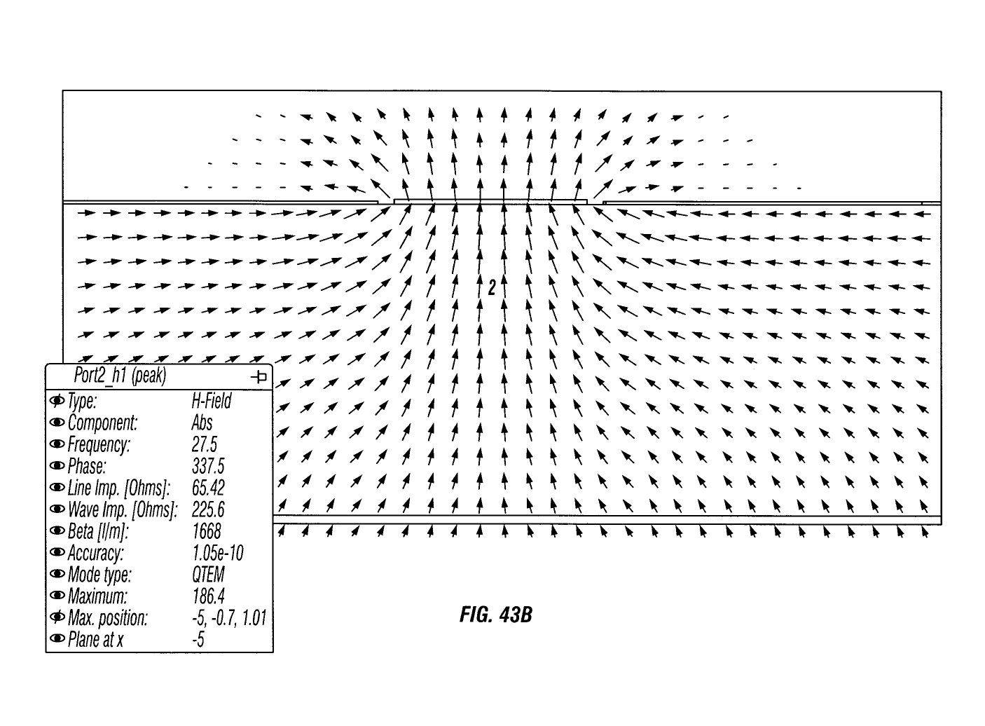

FIG. 41 shows another embodiment of having a dielectric strap 4104 printed on a top side of a substrate 4102. Two metallic plates (not shown), 100 μm apart from the dielectric strap, are printed beside the strap. FIG. 42 is a graph representing the frequency response (S-parameters) of the waveguide with length of 10 mm, width of 1.2 mm, thickness of 2 mm where ε₁=10.2, 68 ₂=300, tan δ₁=0.0023, tan δ₂=0.01, t=20 μm, and thickness of metallic plates of 10 μm. This graph shows the low-loss properties of the waveguide. FIG. 43A-B shows the electric and magnetic near-field distributions of the structure, respectively. The electric field is perpendicular to the plate and tangential to the dielectric strap.

Example 11 shows a Co-Planar DS structure for which the whole circuit is only made in the first surface of the dielectric substrate; therefore has all the advantages of Co-Planar microwave structures, for instance, ease of fabrication process, testing with probes, etc.

In Example 11, the separation between the dielectric film and the metal films in both sides is 100 um. By reducing the substrate thickness from 2 mm to 1 mm, the same performance is achieved, only the impedance of the line is increased from 65 Ohm to 100 Ohm, illustrating the importance of the dielectric substrate in all DS structures.

### EXAMPLE 12

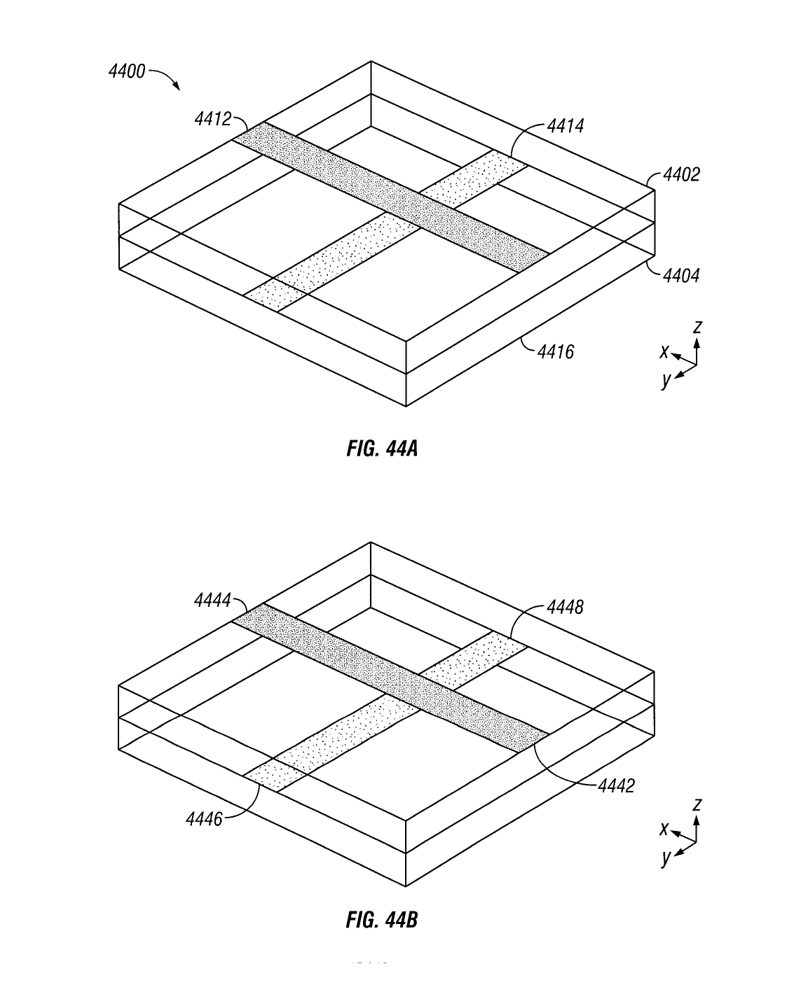

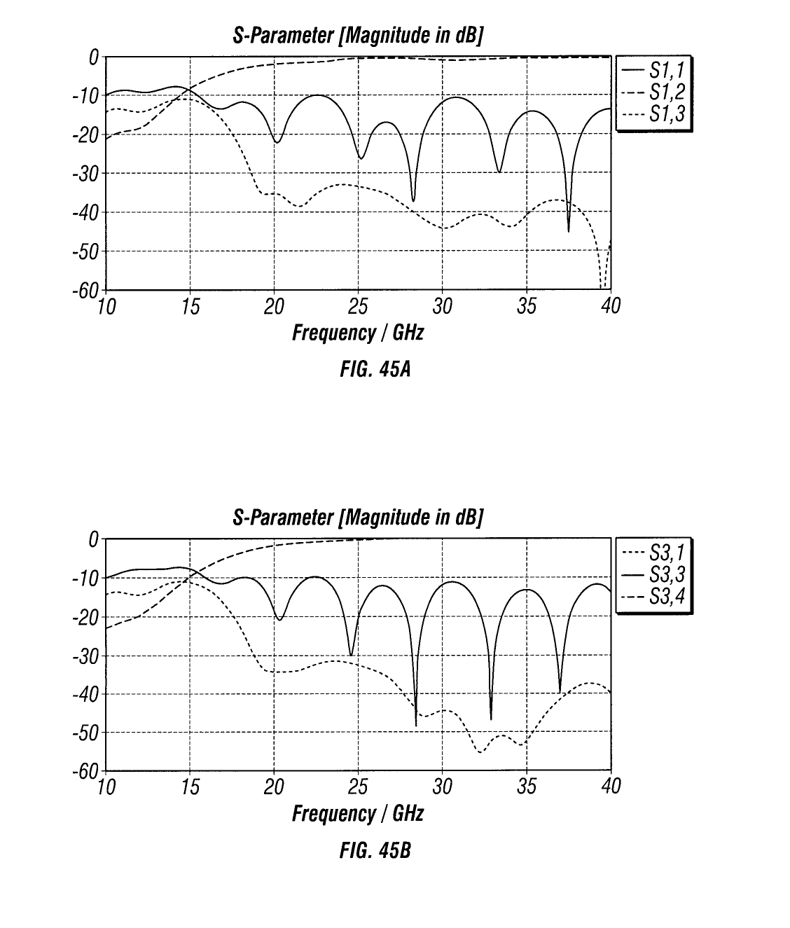

FIGS. 44A-B show an embodiment of a DSW 4400 having a Multilayer DSW (MDSW) in a two-layer configuration having at least a first 4402 and a second 4404 dielectric substrate layer on a metallic ground 4416, and at least two dielectric straps 4412 and 4414, each printed on a top side of one of the substrates 4402 and 4404, respectively. The DSW 4400 may also be configured with ports, as shown in FIG. 44B, including a first port 4442, a second port 4444, a third port 4446, and a fourth port 4448. FIGS. 45A-B are graphs representing the frequency response (S-parameters) of the MDSW with length of 10 mm, width of both straps 1.2 mm, thickness of both substrate layers 1 mm where the permittivity of the first substrate ε₃=5, the permittivity of the second substrate ε₂=10.2, the permittivity of the straps ε₃=300, and the thickness of both straps t=20 μm. For example, the 20 μm air gap between the two substrates may be filled with second substrate. FIG. 45A shows the response of the port 1, and FIG. 45B shows the response of port 3. Both graphs, nearly identical, show that the energy coupled into one end of each strap line will be transmitted almost completely to the other end in frequencies higher than cutoff frequency, while in this case a good isolation is demonstrated between the two separate strap lines.

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than the one shown may include some or all of the features of the depicted embodiment. For example, components may be combined as a unitary structure and/or alternate geometries may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A microwave device comprising:
a dielectric film having a first electrical permittivity;
a dielectric substrate having a second electrical permittivity that is less than the first electrical permittivity; and
a ground plane,
wherein the ground plane is separated from the film by at least the dielectric substrate.

2. The microwave device of claim 1, wherein the dielectric film is a ceramic dielectric film.

3. The microwave device of claim 2, wherein the ceramic dielectric film has been densified by sintering.

4. The microwave device of claim 3, wherein the sintering is carried out at a temperature under approximately 1000 degrees Celsius.

5. The microwave device of claim 1. wherein the first electrical permittivity is at least about 15 times greater than the second electrical permittivity.

6. The microwave device of claim 5, wherein the first electrical permittivity is between about 29 and 34 times greater than the second electrical permittivity.

7. (canceled)

8. The microwave device of claim 1. wherein the device comprises a waveguide having a characteristic impedance of between about 10 Ω and 100 Ω.

9. The microwave device of claim 1, wherein the device additionally comprises at least one input port and one output port.

10. The microwave device of claim 9, wherein the device comprises a microwave coupler having multiple input/output ports.

11. The microwave device of claim 1, wherein the device operates within a frequency range between approximately 1 GHz and 300 GHz.

12. The microwave device of claim 1, wherein the dielectric film has a thickness of between about 10 nm and about 200 μm.

13. The microwave device of claim 1, wherein the dielectric substrate has a dielectric loss tangent of between about 0.00001 and 0.2.

14. The microwave device of claim 13, wherein the dielectric substrate has a dielectric loss tangent of about 0.0023.

15. The microwave device of claim 1, further comprising at least a second dielectric film.

16. The microwave device of claim 15, wherein the second dielectric film has a third electrical permittivity.

17. The microwave device of claim 1, wherein the device comprises a directional coupler.

18. The microwave device of claim 1. wherein the device comprises a directional microwave coupler.

19. The microwave device of claim 1, wherein the device comprises a filter.

20-28. (canceled)

29. The microwave device of claim 1, wherein the device comprises at least a waveguide and an antenna.

30. The microwave device of claim 1, wherein the device comprises a plurality of any of a waveguide, a filter, a coupler and an antenna.

31. (canceled)

32. A method for manufacturing microwave devices, comprising:
obtaining a dielectric substrate having at least a first and a second surface a first electrical permittivity;
obtaining a backing layer;
printing a dielectric film onto the first surface of the dielectric substrate; and
coupling the backing layer to the second surface of the dielectric substrate, wherein the dielectric film has a second electrical permittivity that is greater than the first electrical permittivity.

33. The method of claim 32, wherein the backing layer is a ground plane.

34. The method of claim 32, wherein the dielectric film is a ceramic dielectric film.

35. The method of claim 34, wherein the ceramic dielectric film is printed onto the first surface of the dielectric substrate.

36. The method of claim 34, wherein the ceramic dielectric film is densified by sintering.

37-57. (canceled)

58. An electronic device, comprising:
a filter comprising:
at least one microwave device, comprising:
a dielectric film having a first electrical permittivity;
a dielectric substrate having a second electrical permittivity that is less than the first electrical permittivity; and
a ground plane,
wherein the ground plane is separated from the film by at least the dielectric substrate.

59. The electronic device of claim 58, wherein the filter is a high-pass filter.

60. The electronic device of claim 59, wherein the filter is a band-pass filter:

61. The electronic device of claim 59, wherein the filter is a low-pass filter:

62-80. (canceled)
